(19) United States
(12) Patent Application Publication
(10) Pub. No.: US 2005/0181142 A1
(43) Pub. Date: Aug. 18, 2005

(54) Spray coating apparatus and spray coating method

(76) Inventors: Katsumi Hirano, Nishikyo-ku (JP); Katsuhiro Takeshita, Osaka (JP); Akihiro Kanakura, Osaka (JP); Satoshi Yamasaki, Aichi-gun (JP)

Correspondence Address: JACKIE JAY SCHWARTZ, 1350 Broadway, Suite 1510, NEW YORK, NY, 10018, US

(21) Appl. No.: 10/981,394

(22) Filed: Oct. 29, 2004

(30) Foreign Application Priority Data
Oct. 31, 2003 (JP) 2003-372645

(51) Int. Cl. B05D 1/02

(52) U.S. Cl. 427/421.1

(57) ABSTRACT

By forming an air flow in which a quantity and a blowoff angle of the air supplied toward an atomized spray paint flow don't influence a coating pattern, there are provided a coating apparatus and a coating method, each of which does not disturb the coating pattern, does not require conditions such as wind speed and temperature of a conventional coating booth, and can perform remarkable reduction in an air conditioning energy of the coating booth, prevention of scatter of a paint, and an improvement in a paint adhesion efficiency. In a spray coating apparatus which possesses a casing and an injection nozzle provided in a tip side of the casing and which forms a coating pattern by injecting paint and shaping air from the injection nozzle to thereby form a coating film on a coated object, a first adapter which blows off the air in an injection direction of the injection nozzle is provided on an substantially concentric circle of the injection nozzle, and the first adapter covers, by blowing off the introduced air while giving it a blowoff angle slanting toward a circumferential direction, an outer periphery of the coating pattern near the injection nozzle with the air.

### CROSS-REFERENCE TO RELATED APPLICATIONS

This application is based upon and claims the benefit of priority from the prior Japanese Patent Application No.2003-372645 filed on Oct. 31 in 2003, the entire contents of which is incorporated herein by reference.

### FIELD OF THE INVENTION

The present invention relates to an atomized spray coating apparatus and a coating method, which are used in an automobile coating and a building exterior coating and, especially, are for to a remarkable reduction in air conditioning energy, paint scatter prevention and an improvement in paint adhesion rate in a spray coating.

### BACKGROUND OF THE INVENTION

Conventionally, there have been attempted to prevent a paint from scattering by forming an air flow which deflects paint particles atomized by an injection spray to a coated object direction, and to relieve a booth room air conditioning by performing the air conditioning by adjusting a temperature, humidity and the like of the supplied air to thereby promote a volatilization of solvent such as water in the paint. For example, as shown in Patent Document 1 (JP-A-2000-325860), there has been proposed an electrostatic coating method which atomizes the paint by using a rotating atomization coating machine possessing an external electrode, wherein the air whose temperature and humidity have been controlled is supplied, while being directed to substantially the same direction as moving directions of atomized paint particles to a coated object and from a point behind than a paint injection port, to the circumference of an atomized paint particles pattern so as to contact with this pattern.

According to this, an inherent, excellent finished external appearance (an aluminum orientation property, a smoothness and the like) by the rotating atomization coating machine can be finished under a state that the aluminum orientation property is good and there is no accumulation of the paint even in conditions that the temperature is low and the humidity is high in the booth. Further, an adhesion efficiency of the paint by the rotating atomization coating machine can be remarkably improved and, additionally, contamination of the coating machine and the external electrode by blowing-back of the paint particles can be reduced.

However, in this method of the Patent Document 1, since the air (referred to as shield air) supplied to an outer periphery of the atomized paint particles pattern is supplied while being directed to substantially the same direction as moving directions of atomized paint particles to the coated object, it is impossible to prevent a turbulence of coating pattern.

Further, since this method supplies the air to the external electrode, it is unavoidable that the paint adhesion efficiency reduces because an induction flow occurs excessively to a bell part. The turbulence of the pattern does not appear markedly under a bell fixed state, but it apparently occurs if the bell is moved.

Further, as shown in Patent Document 2 (JP-A-9-225350), there has been proposed a rotating atomization coating method in which an outer periphery of supply paint is surrounded by compressed air when supplying the paint while being rotation-atomized, wherein temperature adjusting air capable of adjusting the temperature is supplied to a periphery of the compressed air.

According to this, from the fact that the temperature adjusting air capable of adjusting the temperature is supplied to the periphery of the compressed air, the temperature adjusting air suppresses, as the shield air, an outside air induction flow from entering into the compressed air to thereby suppress the temperature of the compressed air from remarkably reducing on the basis of the outside air induction flow, thereby preventing a ratio of solid components in the supply paint from changing. In addition to this, the temperature adjusting air performs also an adjustment which makes the ratio of solid components in the supply paint into suitable one through the compressed air by the fact that it adjusts by itself the temperature of the compressed air on the basis of its temperature adjusting function. For this reason, even if a coating booth temperature is not maintained at a constant temperature, a deterioration in coating finish of the coated object on the basis of the induction flow can be prevented by an existence of the temperature adjusting air.

However, in this method of the Patent Document 2, since the shield air of large gas quantity impinges against the compressed air (shaping air), the shield air is disturbed and eventually the coating pattern is disturbed as well.

Further, in this method, since a blowoff directs to an axial direction, the pattern is disturbed and thus the paint adhesion efficiency is reduced. In order that it is not disturbed, there arises a problem that a heat quantity cannot be supplied sufficiently.

Further, as shown in Patent Document 3 (JP-A-51-63839), there has been proposed one in which the coating is performed while forcibly blowing the air whose temperature is higher and whose humidity is lower than a coating atmosphere toward an atomized paint flow blown from an atomization device to the coated object under an air pressure of such a degree that this paint flow is not disturbed.

According to this, the high temperature and low humidity air enters into an inside of the paint scattering in a foggy form and, for this reason, since volatile components in the paint scattering between a spray gun and the coated object effectively volatilize, defects such as sagging and flow at a coating time don't occur.

However, in this method of the Patent Document 3, since the air (referred to as shield air) widely blown from an air blowing device impinges against the coating pattern of the atomized paint flow blown from the atomization device to the coated object, the coating pattern is disturbed unless such a contrivance that a wind of an inside is made weak and a wind of an outside strong is performed, so that an adjustment of the shield air is difficult.

Like the above, there have been attempted to prevent the paint from scattering by feeding the circumferential air from the rear of the injection nozzle of the coating machine to the front, and to moderate the booth room air conditioning by air-conditioning the supplied air. However, since a quantity and a bowoff angle of the supplied air cannot cope with an atomization angle change of the atomized spray paint particles, the pattern of the coating is disturbed and a problem occurs in the coating itself, so that such attempts were not put to practical use.

### SUMMARY OF THE INVENTION

The present invention provides a coating apparatus and its coating method, which are able to, by forming such a flow of the air that the quantity and the blowoff angle of the air supplied toward the atomized spray paint flow exerts no influence on the atomized pattern of the paint, remarkably reduce an air conditioning energy of a coating booth requiring no conditions such as wind speed, temperature and humidity of a conventional coating booth, prevent the paint from scattering and improve the paint adhesion efficiency without disturbing the coating pattern.

In view of the above-mentioned problems, the inventors earnestly studied and, as a result, reached the present invention.

(1) A spray coating apparatus which possesses a casing and a cylindrical injection nozzle provided in a tip side of the casing and which forms a coating pattern by injecting paint and shaping air from the injection nozzle to thereby form a coating film on a coated object, wherein a first adapter which is provided on an substantially concentric circle of the injection nozzle and which blows off the air in an injection direction of the injection nozzle, and the first adapter, by blowing off the introduced air while giving it a blowoff angle slanting toward a circumferential direction, covers an outer periphery of the coating pattern near the injection nozzle with that air.

Here, the term “coating pattern” means a shape formed by paint particles injected from the injection nozzle.

According to the present invention, since the air introduced to the first adapter is blown off while being given the blowoff angle slanting toward the circumferential direction, it is blown off toward a slanting circumferential direction of the paint pattern in a so-called twisted air form which is twisted in the circumferential direction slanted to the coating pattern injected from the injection nozzle. By this, the blown-off air (twisted air) covers the coating pattern near the injection nozzle without disturbing the coating pattern, so that the scatter of the paint near the injection nozzle can be suppressed. Further, by controlling the temperature, the humidity and the like of the blown-off air, since it is possible to control the temperature and the humidity of an atmosphere in the coating pattern, when performing the coating by injecting the paint comprising the paint particles, the volatile components such as organic solvent and water, and the like, it is possible to adjust an evaporation speed of the volatile components (organic solvent, water and the like) from the injected paint particles, so that an adhesion viscosity of the paint particles can be controlled.

Here, although a method of making the blown-off air into the twisted air is not particularly limited, the following may be provided. For example, there is a method in which an air inlet introducing the air along an injection nozzle direction and an air blowoff port blowing off the introduced air are provided in a cylindrical first adapter, and plural helical grooves are formed in an inner wall face of the first adapter from the air inlet to the air blowoff port. Further, it may be a method in which a guide vane is provided in a movable form in an inside of the cylindrical first adapter to thereby partition the inside, and the air is blown off by juxtaposing the guide vanes in an substantially helical form. In this case, the blowoff angle of the twisted air can be changed by adjusting the angle of the guide vane, and it is desirable.

Further, the temperature, the humidity and the like of the air blown off from the first adapter may be controlled. This control may be performed by connecting, for example, an air generator or the like possessing a function capable of adjusting the temperature, the humidity, the gas quantity and the like to the air inlet of the first adapter, and supplying the air from this air generator. However, the air of this air generator may be used as the shaping air injected from a periphery of the injection nozzle of a coating machine main body.

(2) A spray coating apparatus of (1), wherein the first adapter having an air induction part formed by a double cylinder, an air inlet and an air blowoff port which are formed in both ends of the air induction part, and plural helical grooves formed in an inner periphery face of the air induction part from the air inlet to the air blowoff port.

According to the present invention, since the air introduced from the air inlet of the first adapter is blown off from the air blowoff port while being induced by the helical grooves formed in the inner periphery face of the air induction part, the blown-off air becomes the twisted air directed to the circumferential direction of the coating pattern. By this, the air blown off from the first adapter becomes the so-called twisted air and can more effectively cover the coating pattern without disturbing the paint pattern comprising the paint and the shaping air.

Further, an angle blowing off the twisted air can be changed by changing a slanting angle of the helical groove formed in the inner periphery face of the air induction part. In order to change this blowoff angle, it can be performed by being exchanged with a first adapter having a different slanting angle of the helical groove.

(3) A spray coating apparatus of (2), wherein the first adapter is divided in a direction from the air inlet to the air blowoff port into plural pieces, and each of the pieces is made rotatable in the circumferential direction.

Here, “rotate in the circumferential direction” means to rotate along a circumference of the cylindrical casing.

According to the present invention, since the first adapter is divided into at least more than two pieces and each of the divided pieces is made rotatable in the circumferential direction, it is possible to adjust a shape of a bellows-like groove inducing the air, which is formed in an inner periphery face. By this, even if the coating pattern is changed, it becomes possible to provide the twisted air suitable for the coating pattern by rotating the first adapter to thereby change the shape of the bellows-like groove. Accordingly, even if the coating pattern is changed, since it is possible to cope with the change by changing a position of respective adapter, there is required no labor time for changing it to an adapter having the blowoff angle corresponding to respective coating pattern while corresponding to each coating pattern according to coating conditions and, since it is unnecessary in prior to prepare various adapters whose shapes of the bellows-like groove are different, it becomes economical.

(4) A spray coating apparatus of (1), wherein the first adapter is a hollow cylindrical body and possesses plural air induction holes formed in the cylindrical body while being slanted at a predetermined angle from the air inlet to the air blowoff port.

According to the present invention, since the first adapter is the hollow cylindrical body and possesses plural air induction holes formed in the cylindrical body while being slanted at the predetermined angle from the air inlet to the air blowoff port, the air introduced from the air inlet of the first adapter is blown off from the air blowoff port while being induced by the air induction holes slanted at the predetermined angle, so that the blown-off air becomes the twisted air directed to the circumferential direction of the coating pattern. By this, the air blown off from the first adapter becomes the so-called twisted air and can more effectively cover the coating pattern without disturbing the paint pattern comprising the paint and the shaping air.

(5) A spray coating apparatus of (1), wherein the first adapter possesses an air induction part formed by a double cylinder, an air inlet and an air blowoff port which are formed in both ends of the air induction part, and a movable guide vane which extends from the air inlet side to the air bowoff port side and which partitions an internal space of a main body.

According to the present invention, by changing an angle of the guide vane provided in the first adapter and the like, it is possible to change a shape of the air induction part inducing the air introduced from the air inlet to the air blowoff port, thereby changing a direction of the twisted air blown off from the air blowoff port. By this, even if the coating pattern is changed, since it is possible to cope with the change by changing the angle of the guide vane and the like, there is required no labor time for changing it to an adapter having the blowoff angle corresponding to each coating pattern and, since it is unnecessary to previously prepare various adapters whose shapes of the air induction part are different, it becomes economical.

(6) A spray coating apparatus according to any of (1) to (5), wherein the first adapter is detachable in order to be exchanged with a form corresponds to a shape of the coated object.

According to the present invention, since the first adapter is detachable, a predetermined angle of the air induction hole can be changed by exchanging with a first adapter whose shape corresponds to the shape of the coated object. By this, it is possible to improve an effective adhesion efficiency of the paint to the coated object. That is, in order to improve the effective adhesion efficiency of the paint to the coated object, in a case where the coated object has irregularities, it is desirable that the paint pattern is a small pattern whose spread is small and, in a case where it is a smooth face, it is desirable that the paint pattern is a large pattern whose spread is large. By the way, a spread of the blown-off twisted air becomes small by reducing an angle of the air induction hole, and the spread of the blown-off twisted air becomes large by increasing the angle of the air induction hole. Accordingly, in order to heighten the effective adhesion efficiency of the paint to the coated object, the first adapter is used separately such that, since the coating pattern is made small when coating the coated object of the irregularities, the first adapter whose angle of the air induction hole is small is used in order to correspondingly reduce the spread of the twisted air covering the outer periphery of the coating pattern and, further, since the coating pattern is made large when coating the coated object of the smooth face, the first adapter whose angle of the air induction hole is large is used in order to correspondingly increase the spread of the twisted air.

However, the first adapter which is an adapter for the twisted air can be exchanged with an adapter whose angle is different, or the angle of the adapter itself can be changed as well.

(7) A spray coating apparatus having a casing and a cylindrical injection nozzle provided in a tip side of the casing which forms a coating pattern by injecting paint and shaping air from the injection nozzle to thereby forming a coating film on a coated object, wherein a second adapter which is disposed on an substantially concentric circle of the injection nozzle from the injection nozzle side toward an outside and which has plural blowoff layers respectively blowing off the air in an injection direction of the injection nozzle, and an innermost side among the blowoff layers covers an outer periphery of the coating pattern near the coated object by the blown-off air and an outermost side among the blowoff layers prevents by the blown-off air a diffusion of the air blown off from an inner side among the blowoff layers.

According to the present invention, since the air blown off from the blowoff layer of the inner side covers the outer periphery of the coating pattern near the coated object and, further, the air blown off from the blowoff layer of the outermost side is adjusted so as to prevent the diffusion of the air blown off from the blowoff layer of the inner side, and since the air blown off from the blowoff layer of the outermost side blows off the more outward air than the air blown off from the blowoff layer of the inner side, this outer periphery air blown off from the second adapter covers the outer periphery of the coating pattern near the coated object so as not to disturb the coating pattern, so that there is an effect preventing the scatter of the paint. On this occasion, the outer periphery air blown off from the blowoff layer of the outermost side is adjusted so as to prevent the diffusion of the air blown off from the blowoff layer of the inner side. For this reason, the coating can be performed while controlling the spread of the coating pattern near the coated object without disturbing the coating pattern. Further, as mentioned above, by controlling the temperature, the humidity and the like of the blown-off air, the temperature and the humidity of the atmosphere in the coating pattern are controlled, and it is possible to adjust the evaporation speed of the volatile components (organic solvent, water and the like) from the injected paint particles, so that the adhesion viscosity of the paint particles can be controlled.

(8) A spray coating apparatus having a casing and a cylindrical injection nozzle provided in a tip side of the casing and which forms a coating pattern by injecting paint and shaping air from the injection nozzle to thereby form a coating film on a coated object, wherein a first adapter which is provided adjacently to the injection nozzle and on an substantially concentric circle of the injection nozzle and which blows off the air in an injection direction of the injection nozzle, and a second adapter which is disposed outwardly than the first adapter and on the substantially concentric circle of the injection nozzle from the injection nozzle side toward an outside and which has plural blowoff layers respectively blowing off the air in the injection direction of the injection nozzle, the first adapter covers, by blowing off the introduced air while giving it a blowoff angle slanting toward a circumferential direction, an outer periphery of the coating pattern near the injection nozzle with that air, and in the second adapter, an inner side among the blowoff layers covers the outer periphery of the coating pattern near the coated object by the blown-off air and an outermost side among the blowoff layers prevents by the blown-off air a diffusion of the air blown off from an inner side among the blowoff layers.

According to the present invention, since the first adapter blowing off the twisted air and the second adapter blowing off the outer periphery air are provided in combination in a coating machine main body, the coating pattern near an injection spray is mainly covered by the twisted air blown off from the first adapter without disturbing it to thereby prevent the paint near the injection spray from scattering, and the scatter of the paint near the coated object can be prevented by controlling the spread of the pattern without disturbing the coating pattern near the coated object by the outer periphery air blown off from the second adapter. Like this, by providing the first adapter and the second adapter in combination, from a vicinity of the injection spray to a vicinity of the coated object, the scatter of the paint and the like can be more effectively prevented without disturbing the coating pattern. Further, as mentioned above, by controlling the temperature, the humidity and the like of the blown-off air, the temperature and the humidity of the atmosphere in the coating pattern can be controlled, and it is possible to adjust the evaporation speed of the volatile components (organic solvent, water and the like) from the injected paint particles, so that the adhesion viscosity of the paint particles can be controlled.

(9) A spray coating apparatus according to any of (1) to (8), wherein an air generator connected to one or two or more of the injection nozzle, which the first adapter or the second adapter adjusts at least one of a temperature, a humidity and a gas quantity.

According to the present invention, since the air generator is connected to one or two or more of the injection nozzle, the first adapter and the second adapter, and since the air blown off from the first adapter and the second adapter is controlled in its temperature, humidity and the like and can effectively perform heating and reduction in the humidity to the paint in the coating pattern, it is possible to adjust the evaporation speed of the volatile components (organic solvent, water and the like) from the injected paint particles, and a sagging and the like of the paint can be prevented. That is, even if the paint whose viscosity is low by being diluted with a solvent and the like is injected from the injection spray, since the solvent and the like volatilize till the paint adheres to the coated object and thus the sagging of the paint and the like do not occur, it is possible to control the adhesion viscosity of the paint particles and the sagging of the paint adhered to the coated object can be prevented and, additionally, it is possible to reduce a load exerted on the coating apparatus. Further, a clogging of the injection spray becomes difficult to occur as well. Additionally, by individually adjusting the temperature, the humidity and the like of the twisted air blown off from the first adapter and the outer periphery air blown off from the second adapter, the sagging of the paint adhered to the coated object and the like are prevented, further so that a more excellent coating finish can be obtained.

(10) A spray coating apparatus according to any of (1) to (9), wherein a control unit computes a temperature, a humidity, a gas quantity and an angle of the air blown off from the adapter in compliance with a kind of the paint and a shape of the coated object, and controls the air generator and the coating machine main body based on the results of this computation.

According to the present invention, since the spray coating apparatus possesses the air generator, a paint supply machine and the like, and since the coating can be performed by carrying out a control by the control unit which computes the temperature, the humidity, the gas quantity and the angle of the air supplied to the first adapter, the second adapter and the like and which controls, on the basis of results of this computation, the air generator, the coating machine and the paint supply device, the coating can be automatically performed by storing a temperature setting of the twisted air and the outer periphery air to a recording device of the control unit by beforehand obtaining by laboratory tests a temperature at which a ratio of solid components in the injected paint becomes a targeted (desired) value, by computing the temperature, the humidity, the gas quantity and the angle of the blown-off air by setting conditions of the targeted coating, and by transmitting results of this computation to the air generator and the coating machine.

(11) A spray coating method which forms a coating pattern by injecting paint and shaping air from an injection nozzle of a spray coating apparatus to thereby form a coating film on a coated object, wherein using the coating apparatus provided on an substantially concentric circle of the injection nozzle blows off the air in an injection direction of the injection nozzle, and the coating is performed such that, within a range where no turbulence occurs in the coating pattern, the air blown off from an air blowoff port while being given a slanting blowoff angle covers an outer periphery of the coating pattern near the injection nozzle.

According to the present invention, by using, in the spay coating apparatus, the coating apparatus possessing the first adapter which blows off the air, so-called twisted air, blown off in the injection direction of the injection nozzle, since the coating is performed such that the air blown off from the first adapter covers the coating pattern outer periphery near the injection nozzle without disturbing the coating pattern, the scatter of the paint near the injection nozzle can be suppressed. Further, by controlling the temperature, the humidity and the like of the blown-off air, the temperature and the humidity of the atmosphere in the coating pattern can be controlled, and it is possible to adjust the evaporation speed of the volatile components (organic solvent, water and the like) from the injected paint particles, so that the adhesion viscosity of the paint particles can be controlled.

(12) A spray coating method which forms a coating pattern by injecting paint and shaping air from an injection nozzle of a spray coating apparatus to thereby form a coating film on a coated object, wherein a use of the coating apparatus having a second adapter which is disposed on an substantially concentric circle of the injection nozzle from the injection nozzle side toward an outside which has plural blowoff layers respectively blowing off the air in an injection direction of the injection nozzle, and the coating is performed such that, within a range where no turbulence occurs in the coating pattern, an innermost side of the blowoff layers covers an outer periphery of the coating pattern near the coated object by the blown-off air and an outermost side among the blowoff layers prevents by the blown-off air a diffusion of the air blown off from an inner side among the blowoff layers.

According to the present invention, by using, in the spray coating apparatus, the coating apparatus possessing the second adapter which has plural blowoff layers blowing off the outer periphery air, since the coating is performed by being adjusted such that the air blown off from the blowoff layer of the inner side of the second adapter covers the outer periphery of the coating pattern near the coated object and the air blown off from the blowoff layer of the outermost side prevents the diffusion of the air blown off from the blowoff layer of the inner side, the outer periphery of the coating pattern near the coated object is covered by the outer periphery air blown off from the second adapter without disturbing the coating pattern, so that the scatter of the paint can be prevented. Further, as mentioned above, by controlling the temperature, the humidity and the like of the blown-off air, the temperature and the humidity of the atmosphere in the coating pattern can be controlled, and it is possible to adjust the evaporation speed of the volatile components (organic solvent, water and the like) from the injected paint particles, so that the adhesion viscosity of the paint particles can be controlled.

(13) A spray coating method which forms a coating pattern by injecting paint and shaping air from an injection nozzle of a spray coating apparatus to thereby form a coating film on a coated object, wherein a use of the coating apparatus having a first adapter which is provided adjacently to the injection nozzle and on an substantially concentric circle of the injection nozzle and which blows off the air in an injection direction of the injection nozzle while giving it a slanting blowoff angle, and a second adapter which is disposed further outwardly than the first adapter and on an substantially concentric circle of the injection nozzle from the injection nozzle side toward an outside and which has plural blowoff layers respectively blowing off the air in the injection direction of the injection nozzle, and the air blown off from the first adapter covers an outer periphery of the coating pattern near the injection nozzle and, as to the air blown off from the second adapter, an innermost side among the blowoff layers covers an outer periphery of the coating pattern near the coated object by the blown-off air and an outermost side among the blowoff layers prevents by the blown-off air a diffusion of the air blown off from an inner side among the blowoff layers, and the coating is performed such that, within a range where no turbulence occurs in the coating pattern, the airs blown off from the first adapter and the second adapter cover a whole outer periphery of the coating pattern in cooperation with each other.

According to the present invention, by using, in the spray coating apparatus, the coating apparatus in which there are provided in combination the first adapter which blows off the air blown off in the injection direction of the injection nozzle (so called twisted air) and the second adapter which is disposed outwardly than the first adapter and on the substantially concentric circle of the injection nozzle from the injection nozzle side toward the outside and which has plural blowoff layers respectively blowing off the air in the injection direction of the injection nozzle, since the coating is performed by adjusting in such a manner that the air blown off from the first adapter covers the coating pattern outer periphery near the injection nozzle without disturbing the coating pattern, that the air blown off from the blowoff layer of the inner side of the second adapter covers the outer periphery of the coating pattern near the coated object, that the air blown off from the blowoff layer of the outermost side prevents the diffusion of the air blown off from the blowoff layer of the inner side, and that, within the range where no turbulence occurs in the coating pattern, the air blown off from the first adapter and the second adapter covers the whole outer periphery of the coating pattern in cooperation with each other, the coating pattern mainly near the injection spray is covered by the twisted air blown off from the first adapter without being disturbed, so that the paint near the injection spray is prevented from scattering. Further, since the spread of the pattern is controlled by the outer periphery air blown off from the second adapter without disturbing the coating pattern near the coated object, the scatter of the paint near the coated object can be prevented. In this manner, by providing the first adapter and the second adapter in combination, it is possible to more effectively prevent, from the vicinity of the injection spray to the vicinity of the coated object, the scatter of the paint and the like without disturbing the coating pattern. Further, as mentioned above, by controlling the temperature, the humidity and the like of the blown-off air, the temperature and the humidity of the atmosphere in the coating pattern can be controlled, and it is possible to adjust the evaporation speed of the volatile components (organic solvent, water and the like) from the injected paint particles, so that the adhesion viscosity of the paint particles can be controlled.

(14) A spray coating method according to any of (11) to (13), wherein the coating is performed by adjusting a temperature and a solvent quantity, which form the coating pattern, in compliance with a kind of the paint and a shape of the coated object by using an air generator which adjusts at least one of a temperature, a humidity and a gas quantity.

According to the present invention, since the air blown off from the first adapter and the second adapter is controlled in its temperature, humidity and the like in compliance with changes in a kind of the paint and a region of the coated object, and since the coating is performed while adjusting the temperature and the solvent quantity of the paint forming the coating pattern, the coating under optimum coating conditions becomes possible, the sagging of the paint adhered to the coated object and the like are prevented, and a coating finish becomes good. Further, even if the paint whose viscosity is low by being diluted by the solvent and the like is injected from the injection spray, since the solvent and the like volatilize till the paint adheres to the coated object and thus the sagging of the paint and the like don't occur, it is possible to control the adhesion viscosity of the paint particles, and it is possible to reduce a load exerted on the coating apparatus. Further, the clogging of the injection spray becomes difficult to occur as well, the labor such as cleaning of the injection spray is reduced, and the coating efficiency is improved.

(15) A spray coating method of (14), characterized in that air generated from the air generator is one used also as the shaping air.

According to the present invention, since the air generated from the air generator is used also as the shaping air, the shaping air is controlled in its temperature, humidity and the like, and it is possible to more effectively adjust the evaporation speed of the volatile components (organic solvent, water and the like) from the injected paint particles, so that the adhesion viscosity of the paint particles can be directly controlled.

(16) A spray coating method according to any of (11) to (15), wherein controlling an air blowoff quantity from the first adapter and/or the second adapter to thereby cause it to substantially coincide with an induction flow rate generated due to the shaping air, a gas quantity and a wind speed of the air when the air arrives at the coated object are made unchangeable from when the air blowoff is null, while maintaining a temperature/humidity adjusting function by the air blown off from each of the adapters.

According to the present invention, since the coating is performed by controlling such that the air blown off from the first adapter and/or the second adapter is caused to substantially coincide with the induction flow rate generated due to the shaping, the gas quantity and the wind speed when the air arrives at the coated object become unchangeable from when the air blown off from each adapter is null, so that the coating pattern in the coated object face is not disturbed, and it is possible to obtain an optimum coating finish. However, the fact that the gas quantity and the wind speed when the air arrives at the coated object are made the same as a case where there is only the shaping air becomes the fact that the gas quantity and the wind speed of the air blown off from each adapter become zero in the coated object face. However, during a period before arriving at the coated object face, the air blown off from each adapter covers the periphery of the paint, and the temperature and the humidity are changed to and maintained at suitable conditions.

Here, “induction flow generated due to the shaping air” means a wind generated around the shaping air. Since the atomized paint particles moved by this wind are scarcely adhered to the coated object, the adhesion efficiency is reduced, and the coating machine main body and the like are contaminated by the paint particles blown back.

In the present invention, since the first adapter and/or the second adapter are/is provided, and since it is adapted such that the outer periphery of the coating pattern injected from the injection spray of the coating machine main body is covered by the twisted air and the outer periphery air (they are generically referred to as shield air) and the like supplied from the adapters, it is possible to reduce a down flow speed of the conventional coating booth, so that a down flow quantity reduces, a range of humidity adjustment at a coating time of aqueous paint becomes wide, and an energy used for the air conditioning is reduced as well. Further, by this shield effect, the scatter of the paint is prevented, the paint adhesion efficiency is increased, a use quantity of the paint can be reduced, and an industrial waste quantity is reduced as well.

Further, by adjusting the temperature, the humidity and the gas quantity of the shield air and the like, it becomes possible to control the adhesion viscosity of the atomized paint without air-conditioning the whole booth like the related art. Especially, in a case of the aqueous paint, when the coating is performed by a wet-on-wet coating, if the shield air whose temperature, humidity and the like have been adjusted at the coating time of a base paint is used, a time for flushing off (preheating) the coating film of the base paint after the coating can be shortened or nullified. Accordingly, the next coating of top clear paint can be started within a short time, and a flush-off process which has been necessary in the related art can be simplified.

Additionally, as to the first adapter, by forming in its inner wall face the air induction part capable of giving the predetermined blowoff angle, and by making it such that the air supplied from the first adapter shields, as the twisted air, the outer periphery of the coating pattern injected from the injection nozzle so as to cover the outer periphery, the coating can be performed while controlling the spread of the coating pattern near the injection nozzle, without disturbing the coating pattern.

Further, since the second adapter has the blowoff layers partitioned in many layers, and since it is adjusted in such a manner that the air blown off from the blowoff layer of the inner side among the many layers covers the outer periphery of the coating pattern near the coated object and that the air blown off from the blowoff layer of the outermost side prevents the diffusion of the air blown off from the blowoff layer of the inner side, the coating can be performed while controlling the spread of the coating pattern near the coated object without disturbing the coating pattern.

### BRIEF DESCRIPTION OF THE DRAWINGS

FIG. 1 is a partially broken side view showing a first embodiment of a spray-coating apparatus of the present invention;

FIG. 2 is a front view of the first embodiment of FIG. 1;

FIG. 3A is a perspective view showing a first adapter mounted to the first embodiment;

FIG. 3B is a front view showing the same;

FIG. 3C is a bottom view showing the same;

FIG. 4 is a partially broken side view showing other implementation mode of the first embodiment shown in FIG. 1;

FIG. 5 is a front view of the implementation mode of FIG. 4;

FIG. 6 is a perspective view showing a first adapter mounted to the implementation mode shown in FIG. 4;

FIG. 7A is a perspective view further showing another first adapter mounted to the spray coating apparatus of the present invention;

FIG. 7B is a front view showing the same;

FIG. 7C is a bottom view showing the same;

FIG. 8 is a partially broken side view showing a main part of still another implementation mode of the first embodiment shown in FIG. 1;

FIG. 9 is a partially broken front view of the implementation mode of FIG. 8;

FIG. 10 is a partially broken side view showing a second embodiment of the spray coating apparatus of the present invention;

FIG. 11 is a front view of the second embodiment of FIG. 10;

FIG. 12 is a partially broken side view showing a main part of another implementation mode of the second embodiment of the spray coating apparatus of the present invention;

FIG. 13 is a front view of the implementation mode of FIG. 12;

FIG. 14 is a partially broken side view showing a main part of still another implementation mode of the second embodiment of the spray coating apparatus of the present invention;

FIG. 15 is a front view of the implementation mode of FIG. 14;

FIG. 16 is a partially broken side view showing a third embodiment of the spray coating apparatus of the present invention;

FIG. 17 is a front view of the embodiment of FIG. 16;

FIG. 18 is a partially broken side view showing a fourth embodiment of the spray coating apparatus of the present invention;

FIG. 19 is a front view of the embodiment of FIG. 18;

FIG. 20 is a system flow diagram of the spray coating apparatus of the present invention, which is controlled by a control unit;

FIG. 21 is a block diagram showing a constitution of the control unit;

FIG. 22 is a whole diagram of a booth in which the spray coating apparatus of the present invention is incorporated;

FIG. 23 is a diagram showing a film thickness distribution of a coating film in a pattern longitudinal direction; and

FIG. 24 is a diagram showing influences on paint adhesion NV by shield air.

### DETAILED DESCRIPTION OF THE PREFERRED EMBODIMENT

Hereinafter, embodiments of the present invention shall be described referring to drawings; However, the present invention is not limited by the embodiments described.

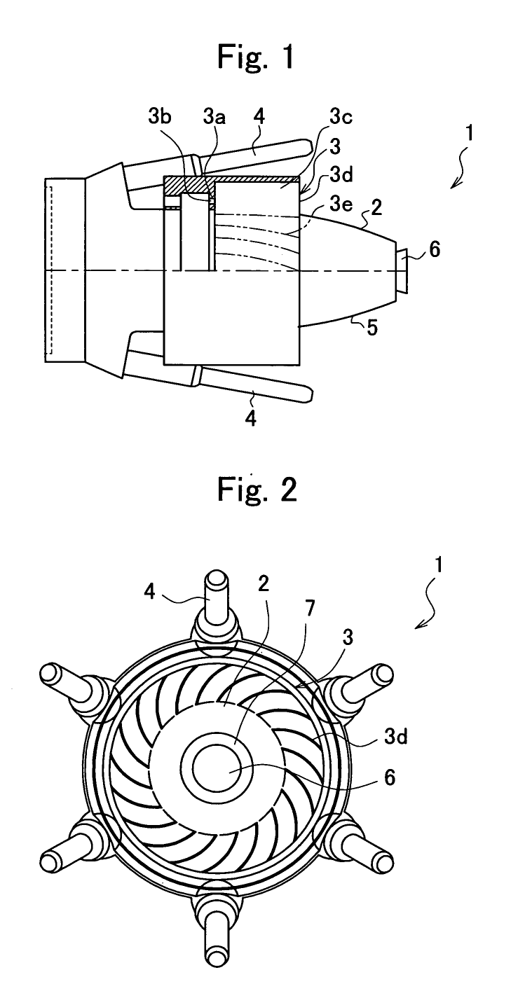

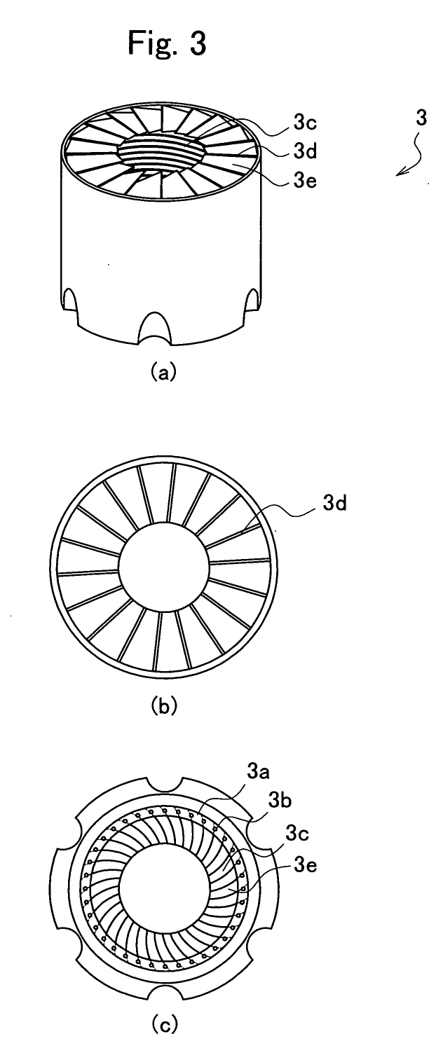

FIG. 1 is a partially broken side view showing a first embodiment of a spray coating apparatus of the present invention, FIG. 2 is a front view of the first embodiment of FIG. 1, FIG. 3A is a perspective view showing a first adapter mounted to the first embodiment, FIG. 3B is a front view showing the same, and FIG. 3C is a bottom view showing the same. However, in these drawings, a dimension is accordingly adjusted so as to be easily understood.

As shown in FIG. 1 and FIG. 2, a spray coating apparatus 1 of the present invention is constituted mainly by a coating machine main body 2, a first adapter 3, and plural electrodes 4 (six pieces in the present embodiment). The coating machine main body 2 is constituted by a casing including of an insulating resin material such as polytetrafluoroethylene for instance and formed in a cylindrical form. In its tip side, there are provided an injection nozzle 6, and a shaping ring 7 jetting shaping air for forward pushing out a paint atomized by the injection nozzle 6. Further, inside the casing 5, there are provided an air motor having an air bearing, a rotating shaft (not shown in the drawing) rotation-driven by the air motor, a paint pipe line (not shown in the drawing) for supplying the paint from a paint supply device to the injection nozzle 6, an air supply pipe line (not shown in the drawing) for supplying the air to the shaping ring 7, and the like.

The cup-like injection nozzle 6 rotatably provided in the tip side of the casing 5 is connected to the rotating shaft in the casing 5. And, the injection nozzle 6 is one which, by the fact, that it is rotated at a high speed by a torque of the rotating shaft, atomizes the paint supplied through the pipe line in a radial direction by a centrifugal force while making it into fine particles. However, the paint used may be any one of an aqueous paint, a solvent paint and a powder paint while being not limited to the spray coating apparatus 1 and including also a spray coating apparatus mentioned later.

Electrodes 4 are extension-provided from a base end side of the casing 5 toward a radial direction outside while being spaced by 60 degrees each in a circumferential direction of the base end side of the casing 5. And, each electrode 4 is one which forms a corona discharge region in its tip side front by the fact that a high voltage of −50 to −90 kV is applied from a high voltage generating device, thereby electrifying the paint particles atomized by the injection nozzle 6.

As shown in FIGS. 3A to 3C, the first adapter 3 is one consisting of the insulating resin material such as polytetrafluoroethylene and formed in the cylindrical form, and has an air induction part 3c formed by a double cylinder. In an air intake side of the air induction part 3c and in a position going inward by a predetermined distance, a wheel edge 3a whose inner diameter is substantially the same dimension as an outer diameter of the casing 5 is vertically provided from an inner periphery face, and plural air inlets 3b are formed in the wheel edge 3a. Further, in an inner periphery face of the air induction part 3c, plural helical grooves 3e are formed toward an air blowoff port 3d from the wheel edge 3a. An inner diameter of the air blowoff port 3d side is formed in substantially the same dimension as the outer diameter of the casing 5, and it is mounted to the coating machine main body 2 while being fitted in a portion between the air blowoff port 3d and the wheel edge 3a. The first adapter 3 is supplied with the air from an air generator (not shown in the drawing) and the like through the air inlet 3b, and this air is induced by the helical groove 3e formed in an inner wall face of the air induction part 3c of the first adapter 3, and blown off to an outside as so-called twisted air (hereafter, this air is referred to as twisted air).

The air is introduced from the air inlet of the first adapter 3, and this air is given a blowoff angle slanting toward a circumferential direction by the helical groove 3e formed in the inner periphery face of the air induction part 3c and blown off from the air blowoff port 3d as the twisted air. This twisted air covers a coating pattern near the injection nozzle.

This twisted air blown off from the first adapter 3 is adjusted in its twisted angle to 20-60° usually by changing plural adapters. However, on this occasion, there may be adopted a structure (not shown in the drawing) in which the first adapter 3 is divided in a longitudinal direction in a ringed form. By this, in order to change the twisted angle of the blown-off air, since it is possible by exchanging a portion of a divided air blowoff port side, a work for exchanging and setting the first adapter 3 when changing the twisted angle of the blown-off air becomes easy, and an exchange work is improved.

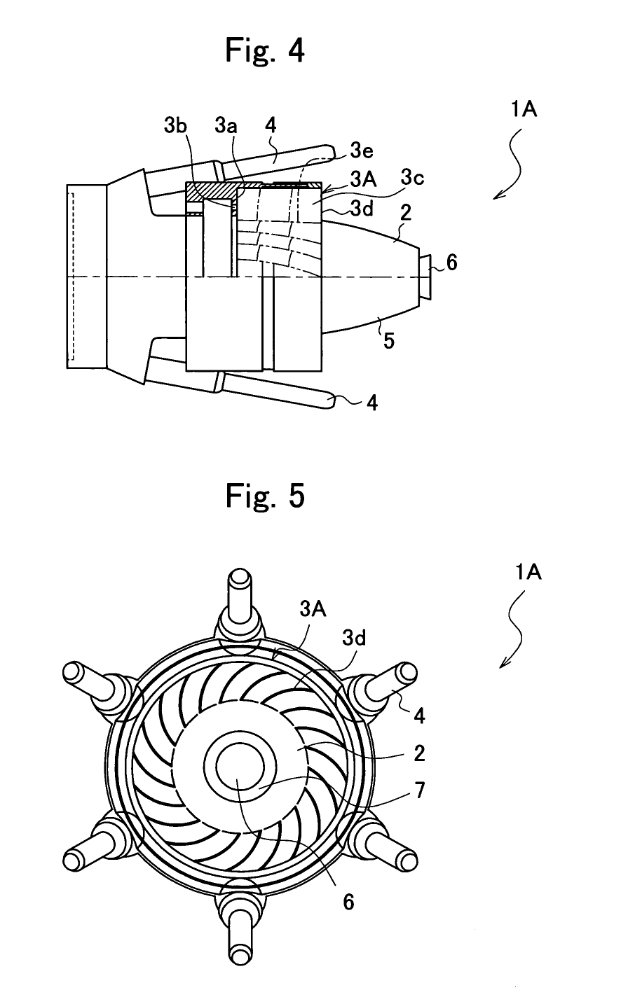

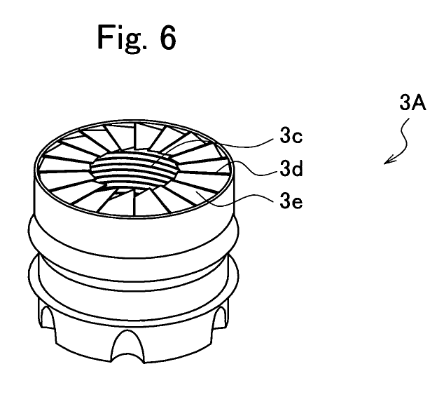

Next, by FIG. 4 to FIG. 6, it is explained about other implementation mode of the first embodiment. FIG. 4 is a partially broken side view showing other implementation mode of the first embodiment shown in FIG. 1, FIG. 5 is a front view of the implementation mode of FIG. 4, and FIG. 6 is a perspective view showing a first adapter mounted to the implementation mode shown in FIG. 4. However, in the following embodiment, the same reference numeral is applied to the same constitution element as the first embodiment, and its duplicate explanation is omitted. Further, in the drawings, the dimension is adjusted accordingly so as to be easily understood.

In a spray coating apparatus 1A of this other implementation mode, a first adapter 3A blowing off the twisted air is constituted by dividing the first adapter 3 of the first embodiment in the longitudinal direction in the ringed form into three pieces (refer to FIG. 6), and these divided pieces are rotatably connected. That is, the first adapter 3A is one consisting of the insulating resin material such as polytetrafluoroethylene similarly to one of the first embodiment and formed in the cylindrical form, and has the air induction part 3c formed by the double cylinder. In the air intake side of the air induction part 3c and in the position going inward by the predetermined distance, the wheel edge 3a whose inner diameter is substantially the same dimension as the outer diameter of the casing 5 is vertically provided from the inner periphery face, and plural air inlets 3b are formed in the wheel edge 3a. Further, in the inner periphery face of the air induction part 3c, plural helical grooves 3e are formed toward the air blowoff port 3d from the wheel edge 3a. A portion between the air inlet 3b and the-air blowoff port 3d is divided into three pieces, and each piece is made rotatable. For this reason, by rotating each piece, since a shape of the helical groove 3e formed in the inner wall face of the air induction part 3c of the first adapter 3A can be changed, even in a case where the coating pattern is changed, it becomes possible to provide the twisted air suitable for the coating pattern by rotating the first adapter 3A to thereby change the shape of the helical groove 3e. Accordingly, since a labor time for changing, any time the coating pattern is changed, the adapter to an adapter corresponding to the changed pattern is unnecessary, and since it is unnecessary to previously prepare various adapters whose shapes of the helical groove 3e are different, it is economical.

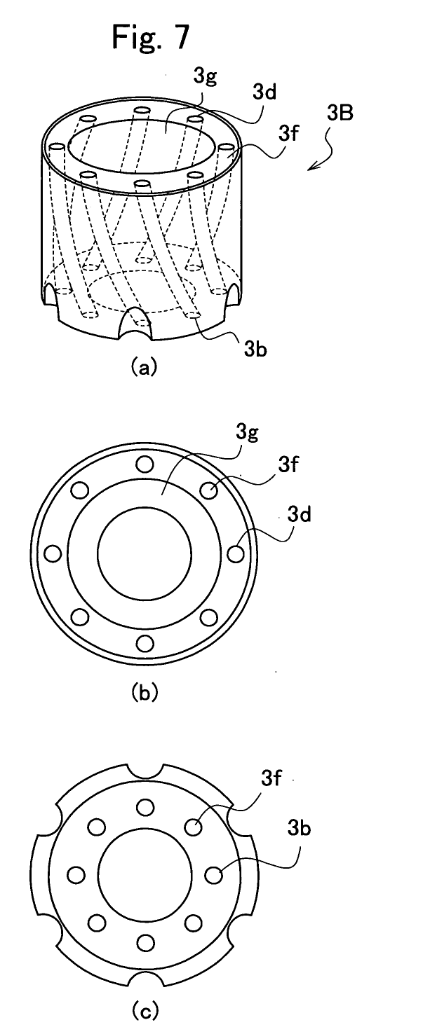

Next, FIGS. 7A to 7B, to explain further on another first adapter mounted to the spray coating apparatus of the present invention. FIG. 7A is a perspective view showing further on another first adapter mounted to the spray coating apparatus of the present invention, FIG. 7B a front view showing the same, and FIG. 7C a bottom view showing the same. However, in the following embodiment, the same reference numeral is applied to the same constitution element as the first embodiment, and its duplicate explanation is omitted. Further, in the drawings, the dimension is accordingly adjusted so as to be easily understood.

A first adapter 3B shown in FIG. 7A to FIG. 7C is formed of the insulating resin material such as polytetrafluoroethylene similarly to one of the first embodiment and formed in a cylindrical form having a hollow portion 3g. On a concentric circle when seen from front, there are formed plural (8 in the present embodiment) air induction holes 3f each of which communicates from the air inlet 3b side toward the air blowoff port 3d side and slants in a predetermined angle. A slanting angel of the air induction hole 3f is, for example, 30°, 45° and the like, and may be set accordingly in compliance with a size of the coating pattern. A spread of the blown-off twisted air is changed by a size of the slanting angle. The hollow portion 3g is one for mounting the first adapter 3B to the coating machine main body 2 (refer to FIG. 1) while being fitted, and exhibits substantially the same shape as an outer periphery shape of the coating machine main body.

The first adapter 3B is mounted to the coating machine main body 2 (refer to FIG. 1) similarly to the first adapter 3 of the first embodiment by fitting the hollow portion 3g to the coating machine main body 2. And, the air is introduced from the air inlet 3b, and this air is given a predetermined blowoff angle slanting toward a circumferential direction during a pass through the air induction hole 3f, and blown off from the air blowoff port 3d as the twisted air. This twisted air covers the coating pattern near the injection nozzle.

This twisted air blown off from the first adapter 3B is adjusted in its twisted angle usually by being exchanged with plural adapters having the air induction hole of angle of 20°-60°. However, at this time, the form may adopt a structure (not shown in the drawing) in which the first adapter 3B is divided in the longitudinal direction in the ringed form. By this, in order to change the twisted angle of the blown-off air, since it is possible by exchanging the portion of the divided air blowoff port side, the work for exchanging and setting the first adapter 3B when changing the twisted angle of the blown-off air becomes easy, and the exchange work is improved.

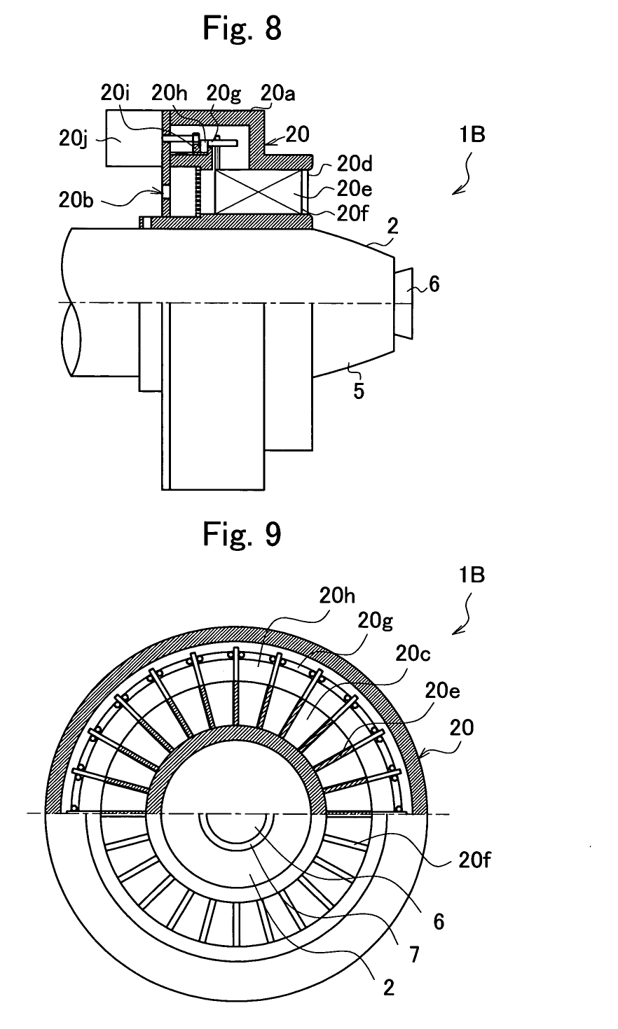

Next, FIG. 8 and FIG. 9 to further explain on another implementation mode of the first embodiment. FIG. 8 is a partially broken side view showing further a main part on another implementation mode of the first embodiment shown in FIG. 1, and FIG. 9 a partially broken front view of the implementation mode of FIG. 8. However, in the following embodiment, the same reference numeral is applied to the same constitution element as the first embodiment, and its duplicate explanation is omitted. Further, in the drawings, the dimension is accordingly adjusted so as to be easily understood.

A spray coating apparatus 1B of this further other implementation mode is one in which, as a first adapter 20 blowing off the twisted air, its inside is partitioned in plural number by guide vanes 20e vertically provided in the circumferential direction, and has a structure in which a space part partitioned by the guide vanes 20e becomes an air induction part 20c, and the air introduced from an air inlet 20b is induced thereby and blown off from an air blowoff port 20d toward the coating pattern. However, in FIG. 8 and FIG. 9, the electrode 4 shown in FIG. 1, FIG. 2, FIG. 4 and FIG. 5 is omitted.

As shown in FIG. 8 and FIG. 9, the first adapter 20 is formed of the insulating resin material such as polytetrafluoroethylene and formed substantially in the cylindrical form, and comprises a casing 20a formed by an substantially cylindrical double cylinder forming an outer shape, and the plural guide vanes 20e provided in the casing. The guide vane 20e is a plate-like one (refer to FIG. 9) vertically provided on a radial line toward the circumferential direction. Its tip part (right hand direction in FIG. 8) is supported by a guide vane supporting shaft 20f formed in the air blowoff side, and the other tip part (left hand direction in FIG. 8) is connected to a cylindrical driving pin unit 20g provided on a concentric circle of the first adapter 20. Additionally, the driving pin unit 20g is connected to a doughnut type disc shape drive ring 20h provided on the concentric circle of the first adapter 20. And, the drive ring 20h is meshed with a driving gear wheel 20i interlocking with a drive device 20j provided outside the casing 20a. By this, the guide vane 20e can be operated and, by changing an angle of the guide vane 20eand the like by the drive device 20j, it becomes possible to change a direction of the twisted air blown off from the first adapter 20, so that the labor required for exchanging the adapter is unnecessary for each time the coating pattern is changed and is also not necessary to prepare in advance various adapters whose shapes of the air induction part 20c are different, which is economical. However, as a method of operating the guide vane 20e, it is not limited to the above gear wheel system, and it may be, for example, a cylinder system and the like.

However, a material of the first adapters 3, 3A, 3B, 20 is not limited to the above insulating resin material, and it may be any of a synthetic resin, a resin-coated metal material, a ceramic and the like. Further, in a case of electrostatic coating, it is desirable to use an insulating material.

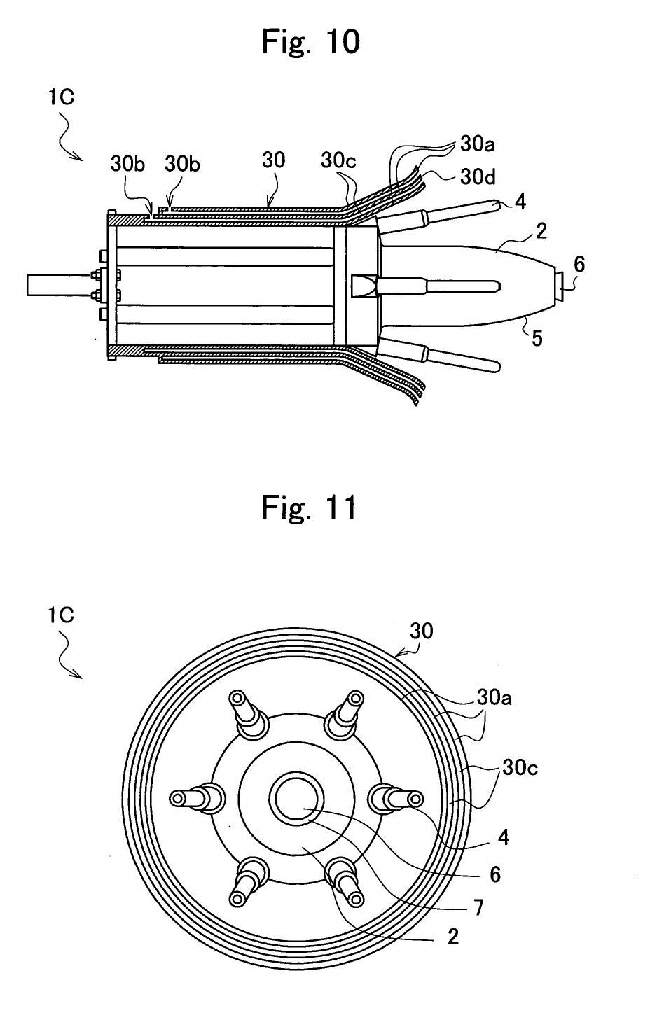

Next, by FIG. 10 and FIG. 11, it is explained about a second embodiment.

FIG. 10 is a partially broken side view showing a second embodiment of the spray coating apparatus of the present invention, and FIG. 11 is a front view of the second embodiment of FIG. 10. However, in the following embodiment, the same reference numeral is applied to the same constitution element as the spray coating apparatus of the first embodiment, and its duplicate explanation is omitted. Further, in the drawings, the dimension is accordingly adjusted so as to be easily understood.

As shown in FIG. 10 and FIG. 11, a spray coating apparatus 1C is one in which there is provided a cylindrical triple-tube second adapter 30 blowing off an outer periphery air to the outer periphery of the coating machine main body 2 possessing plural electrodes 4 (six pieces in the present embodiment) so as to cover the coating pattern and/or the twisted air. In the second adapter 30, a blowoff layer 30c is made a two-layer structure, and exhibits in its longitudinal section an substantially “dogleg” shape whose tip (right hand direction in FIG. 10) of the air blowoff side is directed outward. Further, a tip (air blowoff side) of the blowoff layer 30c of an outer side is directed more outward than a tip of the blowoff layer 30c of an inner side. By this, there is obtained a structure in which the air blown off from the blowoff layer 30c of the outer side can be blown off more outward than the air blown off from the blowoff layer 30c of the inner side. The outer periphery air blown off from the second adapter 30 covers the outer periphery of the coating pattern near the coated object so as not to disturb the coating pattern, and brings about an effect preventing the scatter of the paint. On this occasion, since the outer periphery air blown off from the blowoff layer 30c of the outer side is adjusted so as to prevent the diffusion of the air blown off from the blowoff layer 30c of the inner side, the coating can be performed while controlling the spread of the coating pattern near the coated object without disturbing the coating pattern.

The outer periphery air blown off from the second adapter 30 adjusts the spread by adjusting an air quantity and an air pressure from an air inlet 30b.

Additionally, there may be adopted a constitution in which the tube of the outermost side of the second adapter 30 can be slid in a left/right direction. By this, besides performing the adjustment by adjusting the above spread of the outer periphery air by adjusting the air quantity and the air pressure from the air inlet 30b, by performing an adjustment of the angle of the outer periphery air blown off from the blowoff layer 30c of the outer side, since it becomes possible to, even if the coating pattern is changed, blow off the outer periphery air corresponding to the changed coating pattern, is preferable.

However, in the present embodiment, the second adapter 30 is made the triple-tube to thereby make the blowoff layer 30c into two layers, but it may be made a multilayer structure of more than triple-tube. Also in this case, the blowoff layer 30c of the outermost side is directed more outward than other blowoff layers 30c of the inner side. Further, it is made the coating apparatus provided with the electrodes 4, but it may be the coating apparatus having no electrodes 4.

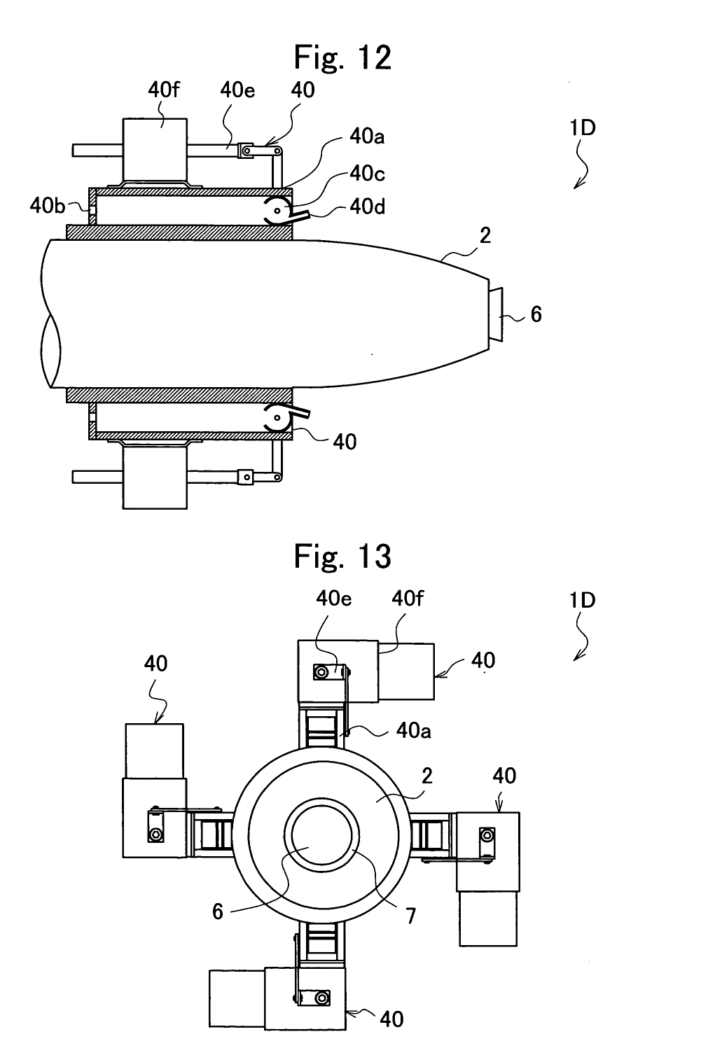

Next, FIG. 12 and FIG. 13 explaining further on about another implementation mode of the second embodiment.

FIG. 12 is a partially broken side view showing a main part of another implementation mode of the second embodiment of the spray coating apparatus of the present invention, and FIG. 13 is a front view of the implementation mode of FIG. 12. However, in the following embodiment, the same reference numeral is applied to the same constitution element as the second embodiment, and its duplicate explanation is omitted. Further, in the drawings, the dimension is accordingly adjusted so as to be easily understood.

As shown in FIG. 12 and FIG. 13, a spray coating apparatus 1D is one in which plural second adapters (four pieces in the present embodiment) 40 blowing off the outer periphery air to the outer periphery of the coating machine main body 2 are provided on a concentric circle of the outer periphery of the coating machine main body 2. The second adapter 40 possesses a cuboid-like casing 40a consisting of the insulating resin material such as polytetrafluoroethylene, and an air induction device 40c having in the casing 40a an air blowoff port 40d in the nozzle 6 side through which the paint is injected. The air induction device 40c is connected to a cylinder 40earticulated to a movable device 40f, and has a structure in which an angle of the air blowoff port 40d of the air induction device 40c is changed by pulling the cylinder 40e by the movable device 40f. By this, the air introduced from an air inlet 40b of the second adapter 40 is blown off from the air blowoff port 40d, which has been set in a predetermined angle, of the air induction device 40c to thereby cover the shaping air and the twisted air, so that as mentioned before, the coating can be performed while controlling the spread of the coating pattern near the coated object without disturbing the coating pattern.

However, in the present implementation mode, in order to explain another implementation mode of the second adapter blowing off the outer periphery air, the explanation has been made about the coating apparatus provided with no electrodes in the second embodiment, but it may be the coating apparatus provided with the electrodes like the second embodiment.

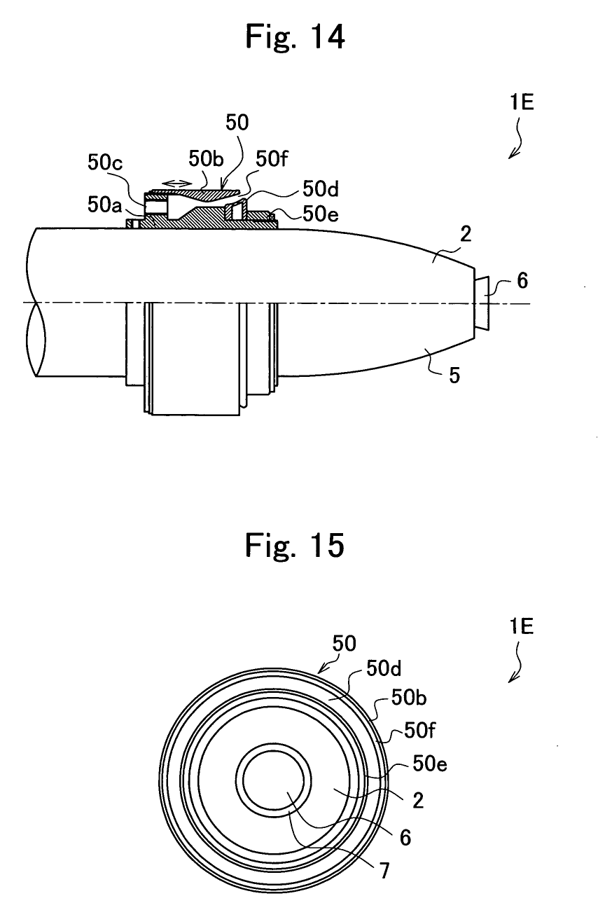

Next, FIG. 14 and FIG. 15 to further explain on another implementation mode of the second embodiment.

FIG. 14 is a partially broken side view showing further a main part of another implementation mode of the second embodiment of the spray coating apparatus of the present invention, and FIG. 15 is a front view of the implementation mode of FIG. 14. However, in the following embodiment, the same reference numeral is applied to the same constitution element as the spray coating apparatus of the second embodiment, and its duplicate explanation is omitted. Further, in the drawings, the dimension is accordingly adjusted so as to be easily understood.

As shown in FIG. 14 and FIG. 15, a spray coating apparatus 1E is constituted by the coating machine main body 2, and a second adapter 50 disposed while being fitted to an outer periphery of the coating machine main body. The second adapter 50 comprises an inner cylinder 50a whose inner diameter is substantially the same dimension as an outer diameter of the casing 5 of the coating machine main body 2 and whose longitudinal section is substantially an L-shape, and an angle adjusting outer cylinder 50b having an inner diameter which is substantially the same dimension as a diameter of an outer side of the inner cylinder. In the inner cylinder 50a, an air inlet 50c is formed in its side opposite to the injection nozzle, and a spread angle adjusting bellows 50d whose section is substantially trapezoid and having hollow space inside is formed in its air blowoff side (injection nozzle 6 side). The bellows 50d can be deformed in a left/right direction by a bellows pushing nut 50e provided in a side opposite to the air inlet. Further, the angle adjusting outer cylinder 50b is fitted in a highest part (top part of the L-shape section) of the air inlet 50c side of the inner cylinder 50a while butting in the form movable in the left/right direction (arrow mark direction in FIG. 14). A space formed between the bellows 50d formed in the inner cylinder 50a and the angle adjusting outer cylinder 50b becomes an air induction part 50f, and the air supplied from the air inlet 50c is induced by the air induction part 50f and blown off as the outer periphery air. On this occasion, a blown-off angle of the outer periphery air is adjusted by moving the angle adjusting outer cylinder 50b in the left/right direction. That is, it is blown off while being directed more outward by moving the angle adjusting outer cylinder 50b in the left hand direction.

However, the material of the above-mentioned second adapters 30, 30A, 40, 50, is not limited to the above insulating resin material such as similar to the first adapters 3, 3A, 3B, 20, and it may be any of the synthetic resin, the resin-coated metal material, the ceramic and the like. Further, in the case of electrostatic coating, it is preferable to use the insulating material.

By doing like the above, as mentioned before, the outer periphery air blown off from the second adapter 50 covers the shaping air and the twisted air, and the coating can be performed while controlling the spread of the coating pattern near the coated object without disturbing the coating pattern.

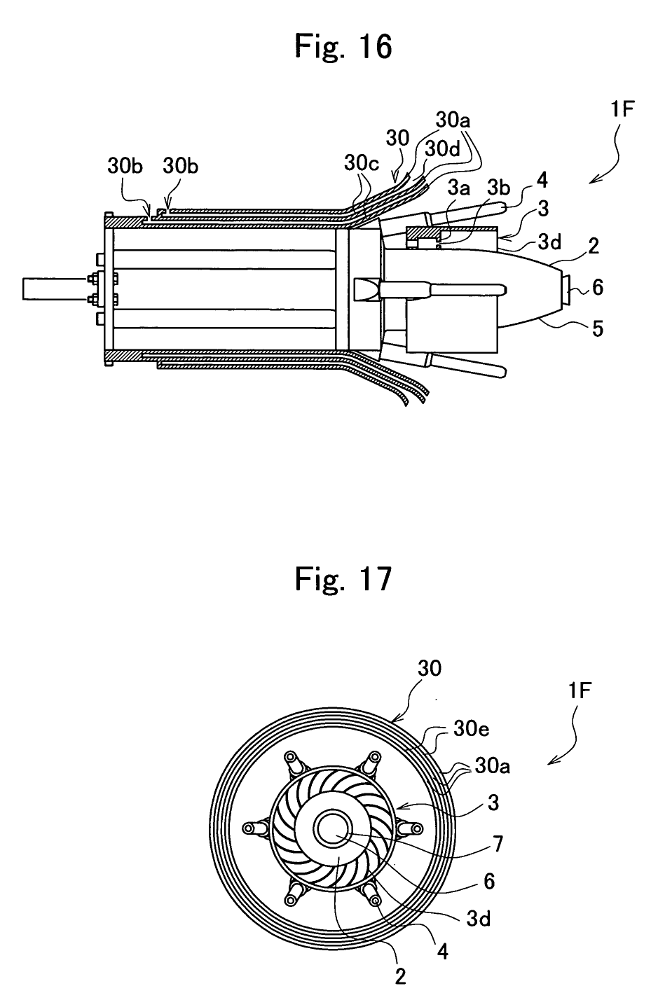

Next, FIG. 16 and FIG. 17 to explain on a third embodiment of the present invention.

FIG. 16 is a partially broken side view showing a third embodiment of the spray coating apparatus of the present invention, and FIG. 17 is a front view of the embodiment of FIG. 16. However, in the following embodiment, the same reference numeral is applied to the same constitution element as the spray coating apparatus of the first embodiment and the second embodiment, and its duplicate explanation is omitted. Further, in the drawings, the dimension is accordingly adjusted so as to be easily understood.

As shown in FIG. 16 and FIG. 17, a spray coating apparatus 1F is constituted mainly by the coating machine main body 2, the first adapter 3 and the second adapter 30 which are mentioned before, and the electrodes 4. Such that, the first adapter 3 explained in the spray coating apparatus 1 of the first embodiment and the second adapter 30 explained in the spray coating apparatus 1C of the second embodiment are provided in combination.

The first adapter 3 is mounted in the vicinity of the injection nozzle 6 to the cylindrical casing 5 of the coating machine main body 2 while being fitted. As mentioned before, the first adapter 3 is one consisting of the insulating resin material such as polytetrafluoroethylene and formed in the cylindrical form, and has the air induction part 3c formed by the double cylinder. In the air intake side of the air induction part 3c and in the position going inward by the predetermined distance, the wheel edge 3a whose inner diameter is substantially the same dimension as the outer diameter of the casing 5 is vertically provided from the inner periphery face, and plural air inlets 3b are formed in the wheel edge 3a. Further, in the inner periphery face of the air induction part 3c, plural helical grooves 3e are formed toward the air blowoff port 3d from the wheel edge 3a (refer to FIGS. 3A to 3C). The inner diameter of the air blowoff port 3d side is formed in substantially the same dimension as the outer diameter of the casing 5, and it is mounted to the coating machine main body 2 while being fitted in the portion between the air blowoff port 3d and the wheel edge 3a. The first adapter 3 is supplied with the air from the air generator (not shown in the drawing) and the like through the air inlet 3b, and this air is induced by the helical groove 3e formed in the inner periphery face of the air induction part 3c of the first adapter 3, and blown off to the outside as the so-called twisted air.

This twisted air blown off from the first adapter 3 is adjusted in its twisted angle to 20-60° usually by changing plural adapters.

On the other hand, the second adapter 30 is disposed on the concentric circle outward the electrodes 4 and in the outer periphery of the coating machine main body 2. As mentioned before, the second adapter 30 consists of the cylindrical triple-tube, is made the blowoff layer 30c of the two-layer structure, and exhibits in its longitudinal section the substantially “dogleg” shape whose tip of the air blowoff side is directed outward. Further, the tip (air blowoff side) of the blowoff layer 30c of the outer side is directed more outward than the tip of the blowoff layer 30c of the inner side. By this, there is obtained the structure in which the air blown off from the blowoff layer 30c of the outer side can be blown off more outward than the air blown off from the blowoff layer 30c of the inner side. The outer periphery air blown off from the second adapter 30 covers the outer periphery of the coating pattern near the coated object so as not to disturb the coating pattern, and brings about the effect preventing the scatter of the paint. On this occasion, the outer periphery air blown off from the blowoff layer 30c of the outer side is adjusted so as to prevent the diffusion of the air blown off from the blowoff layer of the inner side. For this reason, the coating can be performed while controlling the spread of the coating pattern near the coated object without disturbing the coating pattern.

However, the outer periphery air blown off from the second adapter 30 adjusts the spread by adjusting the air quantity and the air pressure from the air inlet 30b. Further, the blowoff layer 30c is not limited to the two-layer structure, ant it may be a structure of three layers or more.

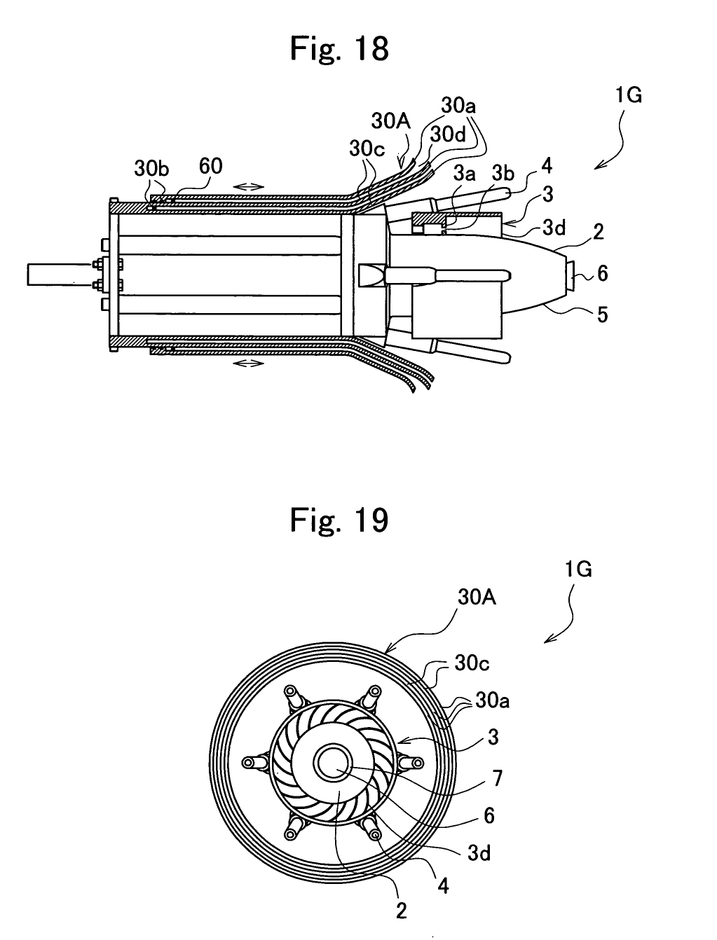

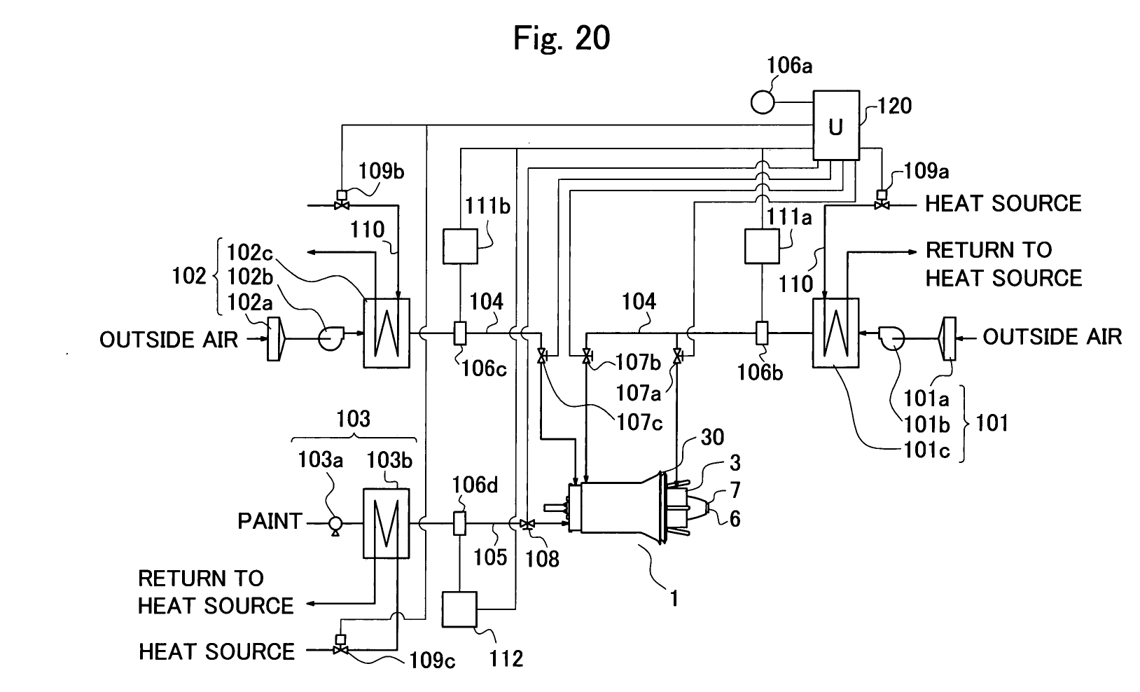

Next, FIG. 18 and FIG. 19 to explain on a fourth embodiment of the present invention.

FIG. 18 is a partially broken side view showing a fourth embodiment of the spray coating apparatus of the present invention, and FIG. 19 is a front view of the embodiment of FIG. 18. However, in the following embodiment, the same reference numeral is applied to the same constitution element as the spray coating apparatus of the first embodiment and the second embodiment, and its duplicate explanation is omitted. Further, in the drawings, the dimension is accordingly adjusted so as to be easily understood.

As shown in FIG. 18 and FIG. 19, a spray coating apparatus 1G is constituted mainly by the coating machine main body 2, the first adapter 3 mentioned before, a second adapter 30A, and the electrodes 4. Such that, the first adapter 3 explained in the spray coating apparatus 1 of the first embodiment, and the second adapter 30, which is explained in the spray coating apparatus 1C of the second embodiment and whose tube 30a of the outermost layer is made slidable in the left/right direction, are provided in combination. That is, the second adapter 30A is one in which, as to the blowoff layer 30c of the outermost side among the blowoff layers of the multilayer structure, its blowoff direction is made changeable.

The first adapter 3 is mounted in the vicinity of the injection nozzle 6 to the cylindrical casing 5 of the coating machine main body 2 while being fitted. As mentioned before, the first adapter 3 is formed of the insulating resin material such as polytetrafluoroethylene and formed in the cylindrical form, and has the air induction part 3c formed by the double cylinder. In the air intake side of the air induction part 3c and in the position going inward by the predetermined distance, the wheel edge 3a whose inner diameter is substantially the same dimension as the outer diameter of the casing 5 is vertically provided from the inner periphery face, and plural air inlets 3b are formed in the wheel edge 3a. Further, in the inner periphery face of the air induction part 3c, plural helical grooves 3e are formed toward the air blowoff port 3d from the wheel edge 3a (refer to FIGS. 3A to 3C). The inner diameter of the air blowoff port 3d is formed in substantially the same dimension as the outer diameter of the casing 5, and it is mounted to the coating machine main body 2 while being fitted by the air blowoff port 3d and the wheel edge 3a. The first adapter 3 is supplied with the air from the air generator (not shown in the drawing) and the like through the air inlet 3b, and this air is induced by the helical groove 3e formed in the inner wall face of the air induction part 3c of the first adapter 3, and blown off to the outside as the so-called twisted air.

This twisted air blown off from the first adapter 3 is adjusted in its twisted angle to 20-60° usually by changing plural adapters.

On the other hand, the second adapter 30A is disposed outward the electrodes 4 and on the concentric circle of the coating machine main body 2. As mentioned before, the second adapter 30A consists of the cylindrical triple-tube, is made the blowoff layer 30c of the two-layer structure, and exhibits in its longitudinal section the substantially “dogleg” shape whose tip in the air blowoff side is directed outward. Further, the tip (air blowoff side) of the blowoff layer 30c of the outer side is directed more outward than the tip of the blowoff layer 30c of the inner side. And, a tube 30a of the blowoff layer 30c of the outer side is slidable in the left/right direction (arrow mark direction in FIG. 18). The tube 30a of the blowoff layer 30c of the outer side is sealed in its air inlet 30b side by an O-ring 60 and, if it is slid in the left/right direction, the air does not leak. By this, even if the coating pattern is changed, the air blown off from the blowoff layer 30c of the outer side can be adjusted so as to be blown off more outward than the air blown off from the blowoff layer 30c of the inner side. The outer periphery air blown off from the second adapter 30A covers the outer periphery of the coating pattern near the coated object so as not to disturb the coating pattern, thereby bringing about the effect preventing the scatter of the paint. Further, the air blown off from the blowoff layer 30c of the outer side is adjusted so as to prevent the diffusion of the air blown off from the blowoff layer 30c of the inner side. For this reason, the coating can be performed while controlling the spread of the coating pattern near the coated object without disturbing the coating pattern.

However, the outer periphery air blown off from the second adapter 30A is adjusted in its spread by adjusting the air quantity and the air pressure from the air inlet 30b. However, the air blown off from the blowoff layer 30c of the outermost side can be adjusted also by sliding the tube 30a of the outermost side in the left/right direction. Further, the blowoff layer 30c is not limited to the two-layer structure, ant it may be the structure of more than three layers or more.

The spray coating apparatus explained above possesses the air generator, a compressor, a paint supply machine and the like, and may be controlled by a control unit which computes the temperature, the humidity, the gas quantity and the angle of the air supplied to the first adapter, the second adapter and the like, and which possesses an interface transmitting results of this computation to the coating apparatus, the air generator, the compressor, the paint supply machine and the like. That is, it may be adapted such that a temperature setting of the twisted air blown off from the first adapter and the outer periphery air blown off from the second adapter is stored in a recording device of the control unit by beforehand obtaining by laboratory tests a temperature at which a ratio of solid components in the injected paint becomes a targeted (desired) value, the temperature, the humidity, the gas quantity and the angle of the blown-off air are computed by setting conditions of the targeted coating, results of this computation are transmitted to the coating apparatus, the air generator, the compressor, the paint supply machine and the like, and thereby each flow regulating valve is controlled.

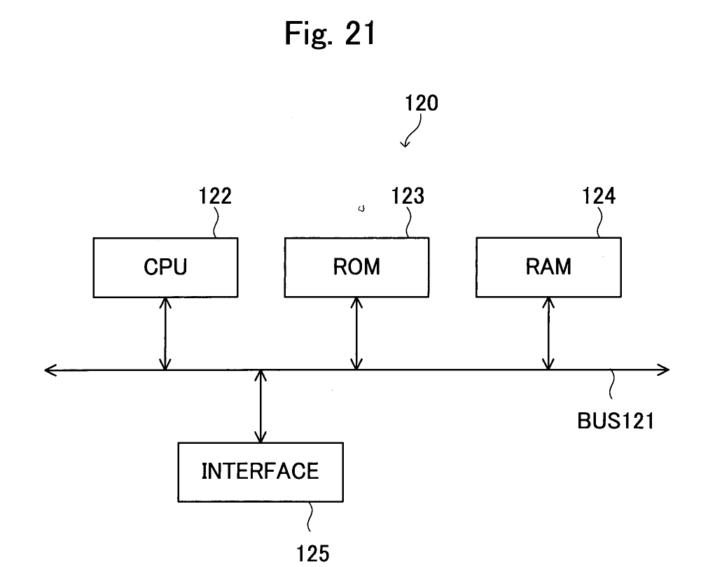

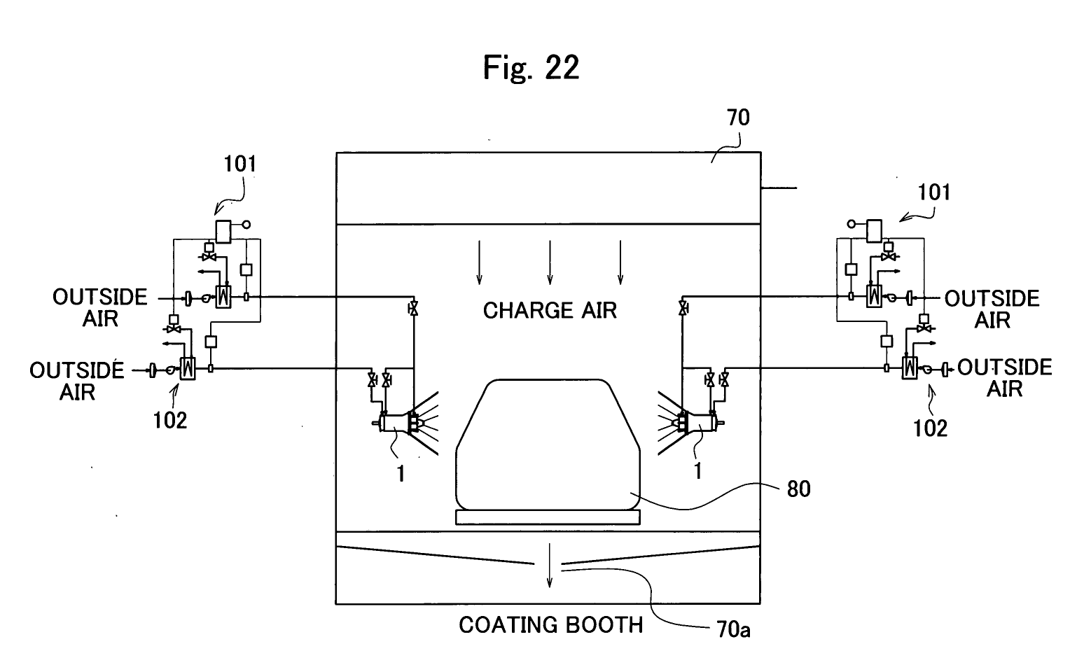

On the basis of FIG. 20 and FIG. 21, more specifically explained about a coating system, in which there is incorporated the above control unit, by the coating apparatus in which the first adapter and the second adapter are provided in combination.

FIG. 20 is a system flow diagram of the spray coating apparatus of the present invention, which is controlled by a control unit, and FIG. 21 is a block diagram showing a constitution of the control unit.

As shown in FIG. 20, this coating system comprises the spray coating apparatus 1 provided with the first adapter 3 and the second adapter 30, an air generator 101 supplying the air to the first adapter 3 and/or the second adapter 30, a compressor 102 supplying the air to the shaping ring 7 of the spray coating apparatus 1, a paint supply machine 103 supplying the paint to the injection nozzle 6 of the spray coating apparatus 1, and a control unit 120.

The air generator 101 is one for supplying the air to the first adapter 3 and/or the second adapter 30 which are/is mounted to the spray coating apparatus 1, comprises a blower 101b introducing the outside air through a filter 101a and a heater 101c heating this introduced air, and supplies the temperature-adjusted air to the first adapter 3 and/or the second adapter 30 through an air supply pipe line 104 possessing a sensor 106b of a temperature/humidity controller 111a, an air flow adjusting valve 107a adjusting the air quantity supplied to the first adapter 3, and an air flow adjusting valve 107b adjusting the air quantity supplied to the second adapter. However, the air generator 101 may be used also for supplying the shaping air to the spray coating apparatus 1.

The compressor 102 is one for supplying the shaping air to the spray coating apparatus 1, similarly to the air generator 101, comprises a blower 102b introducing the outside air through a filter 102a and a heater 102c heating this introduced outside air, and supplies the temperature-adjusted air to the shaping ring 7 through an air supply pipe line 104 possessing a sensor 106b of a temperature/humidity controller 111b, and an air flow adjusting valve 107c adjusting the air quantity supplied to the shaping ring 7.

The paint supply machine 103 comprises a gas compressor 103a force-feeding the paint and a heater 103b heating the paint, and supplies the paint to the injection nozzle 6 through a paint supply pipe line 105 possessing a sensor 106d of a temperature controller 112, and a paint flow adjusting valve 108 adjusting the quantity of the paint supplied to the injection nozzle 6.

However, as to each of the heaters 101c, 102c, 103b, in its inside there is provided a heating medium supply pipe 110, and each heating medium supply pipe 110 possesses in its midway each of electromagnetic heating medium flow regulating valves 109a, 109b, 109c. And, by the heating medium flowing through the heating medium supply pipe 110, an indirect heat exchange with the air or paint forcibly supplied is performed, and thus the temperature-adjusted air and the like are generated. The temperature of the temperature-adjusted air and the like can be adjusted by adjusting a flow rate of the heating medium by the heating medium flow regulating valves 109a, 109b.

As shown in FIG. 21, the control unit 120 is constituted by a data bus (BUS) 121, a CPU 122, a ROM 123, a RAM 124, and an interface 125 which performs a transmission/reception of signals between it and the flow regulating valves 107a-107c, 108, 109a-109c and the sensors 106a-106d etc. of the air generator 101, the compressor 102, the paint supply device 103, and the like.

The CPU 122 is adapted so as to compute the temperature, the humidity, the gas quantity, the angle and the like of the air blown off from the first adapter3, the second adapter 30 and the like in compliance with the kind of the paint and a shape of the paint-adhered object and implement various operations in accordance with a program stored in the ROM 123, thereby controlling each peripheral device/equipment in compliance the various operations. However, in the present embodiment, although the program is recorded in the ROM123, it may be recorded in another recording part and may be recorded in a recording medium such as CD-ROM for instance.

The signals from the sensors 106a-106d are inputted to the control unit 120. The sensor 106a is one detecting an outside air temperature (temperature in the coating booth), the sensor 106b is one detecting temperatures of the twisted air and the outer periphery air, the sensor 106c is one detecting a temperature of the shaping air, and the sensor 106d is one detecting a temperature of the paint. On the other hand, control signals are outputted from the control unit 120, and the control signals are inputted to the air flow adjusting valves 107a, 107b, 107c, the paint flow adjusting valve 108, and the heating medium flow adjusting valves 109a, 109b, 109c. By this, the control unit 120 sets, in view of the outside air temperature, a temperature at which the ratio of the solid components in the injected paint become desired one as a set temperature and, in order to make the temperature-adjusted air temperature into that set temperature, feedback-controls the air flow adjusting valves 107a, 107b, 107c and the heating medium flow adjusting valves 109a, 109b on the basis of the detected temperatures from the sensors 106b, 106c. In this case, when the outside air temperature is a low temperature, the temperatures of the twisted air and the outer periphery air are set so as to be raised in comparison with a case where the outside air temperature is higher than that low temperature.

By this, the coating can be automatically performed by storing the temperature setting of the twisted air and the outer periphery air to the recording device of the control unit by beforehand obtaining by laboratory tests the temperature at which the ratio of solid components in the injected paint becomes the targeted (desired) value, by computing the temperature, the humidity, the gas quantity and the angle of the blown-off air by setting conditions of the targeted coating, and by transmitting results of this computation to the air generator and the coating machine.

Next, it is explained about one constitution example of a whole coating booth possessing the spay coating apparatus 1 of the present invention.

As shown in FIG. 21, in a constitution of the whole coating booth, the spray coating apparatus 1 of the present invention is provided in left and right positions within a coating booth 70 with a coated object 80 being interposed. In the coating booth 70, charge air is supplied from an upper part toward a lower part, and discharged together with a mist of the paint from an exhaust port 70a provided in the lower part. Further, the air generator 101, the compressor 102, the paint supply machine 103 and the like, which are connected to the spray coating apparatus 1 and explained in FIG. 20, are disposed outside the coating booth 70.

Like the above, although the spray coating apparatus concerning the present invention has been specifically explained while referring to the drawings showing the examples, the present invention is not limited by nature to the examples shown in the drawings and can be performed by being added suitable modifications within a scope capable of conforming to the above-mentioned gist, and all of such modified ones are included in a technical scope of the present invention.

Next, it is explained about a coating method using the above-mentioned spray coating apparatus 1F shown in FIG. 16 and FIG. 17.

When performing the spray coating by using the spray coating apparatus 1F of the present invention, the cup-like injection nozzle 6 is rotated by the air supplied from an air motor driving air pipe line (not shown in the drawing), the paint supplied from a paint supply pipe line (not shown in the drawing) is injected forward from a peripheral edge tip part of the injection nozzle 6 by a centrifugal force basing on the rotation of the injection nozzle 6 while the paint is being rotated and spread outward in a radial direction, and the coating is performed to the coated object by the injected paint (supplied paint). Further, at the same time, the air is supplied from a shaping air supply pipe line (not shown in the drawing), and that air is injected from the shaping ring 7 as the shaping air (compressed air). By this, that shaping air surrounds an outer periphery of the paint injected from the injection nozzle 6, thereby forming the coating pattern of the injected paint.

At this time, the temperature-adjusted twisted air is injected toward a circumferential direction of the coating pattern also from the first adapter 3 provided near the injection nozzle 6 and the annular shaping ring 7 and on substantially concentric circle of the injection nozzle 6, and that twisted air surrounds the outer periphery of the coating pattern as mentioned before. At this time, the twisted air is controlled to be low in the speed and be large in the gas quantity in comparison with the shaping air and, when the outside air temperature (temperature in the coating booth) is a low temperature, the outside air temperature is raised in comparison with a case where it is higher than that low temperature. This twisted air covers the coating pattern outer periphery near the injection nozzle without disturbing the coating pattern, so that the scatter of the paint near the injection nozzle can be suppressed.

More specifically, although the temperature setting of the twisted air is performed by beforehand obtaining, by the laboratory tests, the temperature at which the ratio of the solid components in the injected paint becomes the targeted (desired) value, as to a temperature range of the twisted air, about 20-80° C. or so is preferable as a target. As to a flow rate, although it depends on the flow speed and the flow rate of the shaping air, about 1-5 m³/min or so is preferable. Further, as to the flow speed, about 1-5 m/sec or so is preferable. Further, as to a blowoff angle of the twisted air, it is preferable that it is made the circumferential direction of the coating pattern in the meaning of suppressing a turbulence with the shaping air. However, in a case of the aqueous paint, it is desirable that the humidity is accordingly adjusted in a range of about 20-70%.

Further, the temperature-adjusted outer periphery air is blown off also from the second adapter 30 provided outward than the first adapter 3 and on the concentric circle of the injection nozzle 6, and that outer periphery air surrounds outer peripheries of the coating pattern and the twisted air. Since the blowoff layer 30c of the second adapter 30 is made the multilayer structure, the air blown off from the blowoff layer 30c of the inner side covers the outer periphery of the coating pattern near the coated object and, further, the air blown off from the blowoff layer 30c of the outermost side is adjusted so as to prevent the diffusion of the air blown off from the blowoff layer 30c of the inner side. Like in this manner, since the air blown off from the blowoff layer of the outermost side is blown off outward than the air blown off from the blowoff layer 30c of the inner side, this outer periphery air blown off from the second adapter 30 covers the outer periphery of the coating pattern near the coated object so as not to disturb the coating pattern, thereby bringing about the effect preventing the scatter of the paint. On this occasion, the outer periphery air blown off from the blowoff layer 30c of the outermost side is adjusted so as to prevent the diffusion of the air blown off from the blowoff layer 30c of the inner side. For this reason, the coating can be performed while suppressing the spread of the coating pattern near the coated object without disturbing the coating pattern.

More specifically, although the temperature setting of the outer periphery air is performed by beforehand obtaining, by the laboratory tests, the temperature at which the ratio of the solid components in the injected paint becomes the targeted (desired) value, as to the temperature range, about 20-80° C. or so is preferable as a target. As to the flow rate, although it depends on the flow speed and the flow rate of the shaping air, about 1-5 m³/min or so is preferable. Further, as to the flow speed, about 1-5 m/sec or so is desirable. Further, as to an injection angle of the outer periphery air, it is desirable that it is the same as the twisted air or made more than that (more outward) in the meaning of suppressing the turbulence with the shaping air and the twisted air and preventing the scatter of the paint near the coated object.

Like this, from the fact that the twisted air and/or the outer periphery air is supplied to the outer periphery of the coating pattern, the twisted air and/or the outer periphery air suppresses, as the shield air, an outside air induction flow from going into the shaping air of the coating pattern to thereby suppress the temperature of the shaping air from remarkably lowering on the basis of the outside air induction flow, and the temperature of the shaping air is controlled by the twisted air and/or the outer periphery air mixed by being induced by the shaping air, so that the ratio of the solid components in the injected paint is prevented from changing. In addition to this, it is of course that the twisted air and/or the outer periphery air does not lower, on the basis of their temperature adjusting functions, the temperature of the shaping air by themselves, and the twisted air and/or the outer periphery air performs also an adjustment for making the ratio of the solid components in the injected paint into suitable one through the shaping air. For this reason, even if the coating booth temperature is not kept constant, a deterioration of the coating finish of the coated object on the basis of the outside air induction flow can be prevented by existence of the temperature-adjusted twisted air and/or the outer periphery air.

Further, from the fact that the twisted air and/or the outer periphery air blows at a low speed in comparison with the shaping air, an entrainment (generation and entry of the induction air) of the outside air (air in the coating booth) by the twisted air and/or the outer periphery air can be reduced. Moreover, from the fact that twisted air and/or the outer periphery air blows at a low speed and in a large gas quantity in comparison with the shaping air, a pattern of the shaping air is not destroyed, and the fact that the outside air induction flow goes into the shaping air via the twisted air can be made more difficult. For this reason, the deterioration of the coating finish of the coated object on the basis of the induction flow can be prevented further.

However, in the above, it has been explained about the spray coating apparatus 1F in which there are provided in combination the first adapter 3 possessing the air induction part 3c formed by the double cylinder, the air inlet 3b and the air blowoff port 3d which are formed in both ends of the air induction part 3c and the plural helical grooves 3e formed in the inner periphery face of the air induction part 3c, and the second adapter 30 having the multilayer blowoff layers 30c each of which blows off the air in the injection direction of the injection nozzle, but each of the adapters is not limited to this and, even if it is one of such other implementation modes as mentioned before, similar matters can be said. Further, in a case of one possessing either the first adapter 3 or the second adapter 30, the air blown off from each of the adapters respectively brings about such effects as mentioned before.

### EXAMPLES

Test results of the coating method of the present invention are shown below. In the present example, the spray coating apparatus 1 of the present invention shown in FIG. 1 was used, an aqueous base paint of solid component 20 weight % was coated on a vertically provided tinplate sheet of about 0.3 mm in thickness, and a coated sheet was obtained. However, a spacing between the injection nozzle and the coated object was made 220 mm.

As to coating conditions of the aqueous base paint, the number of revolution was made 50000 rpm, a paint discharge quantity 270 cc/min, a shaping air pressure 300 Nl/min, and an applied current 400 μA. Temperatures of the temperature-controlled shield air were the room temperature, 50° C. and 77° C. (humidity 70% RH in all temperatures), and the air whose supply quantity had been set to 2 m³/min was blown off from the first adapter. However, the angle of the twisted air blown off from the first adapter was made 30°.

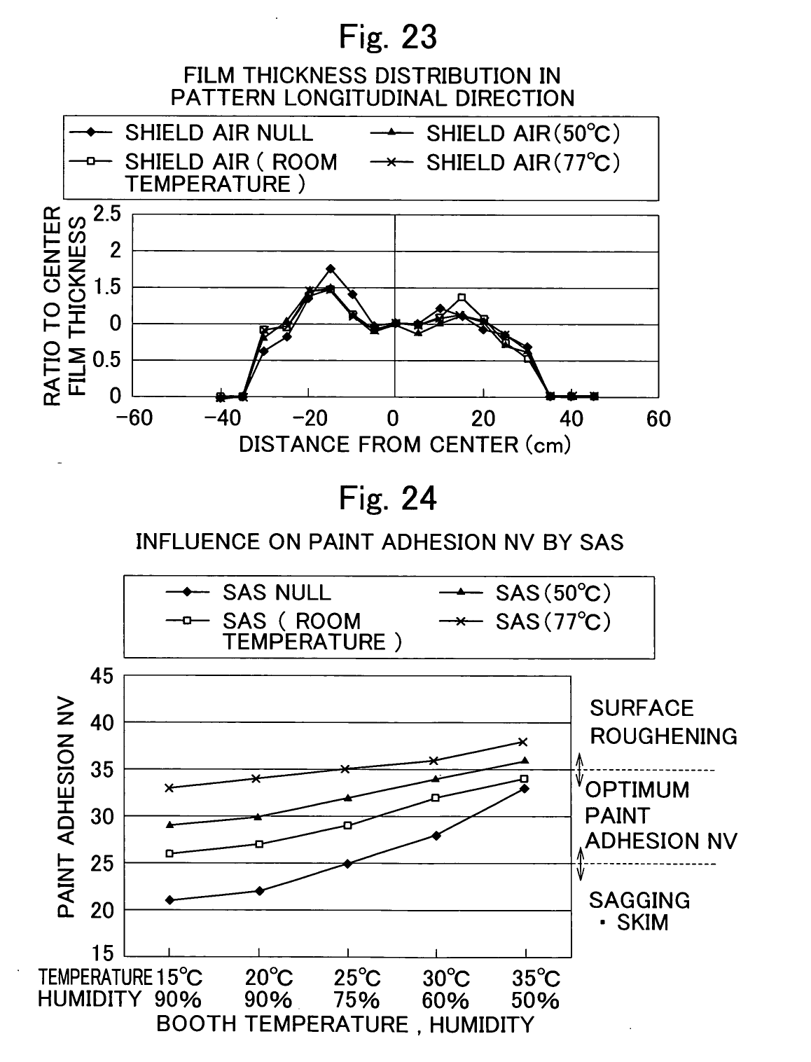

There was measured a film thickness of the coating film adhered to the coated object in a case where the coating was performed by supplying the shield air whose temperature was changed in three stages, and the film thickness from a center part to peripheral parts of the adhered coating film was measured as a film thickness distribution in a pattern longitudinal direction and it was shown in FIG. 23 as a ratio to the film thickness of the center part. By way of comparison, the film thickness distribution in a case where the coating is performed without supplying the shield air.

From its results, there was obtained a tendency that, even if the shield air was supplied, the film thickness distribution was substantially the same as that in a case where there is no shield air. From this fact, it can be said that the coating pattern is not disturbed by the shield air. Further, the film thickness distribution of the coating film in the case where the temperature of the shield air was changed, substantially the same tendency was obtained in each case, so that it was not influenced by the temperature of the shield air as well.

Further, an influence on a paint adhesion NV by the shield air was studied by changing the temperature and the humidity in the booth, and its results were shown in FIG. 24. In the drawing, “SAS” means the shield air. However, the paint adhesion NV means a ratio of the paint solid component coated to the coated object, and it is expressed by NV=[(paint component mass after drying)/(paint component mass before drying)]×100. In the case of the aqueous base paint concerned, when the paint adhesion NV is 25-35% an optimum paint adhesion state is obtained, and if it is smaller than 25% a sagging and a popping occur and if it is larger than 35% a surface roughening occurs, so that a finish becomes deteriorated.

From these results, in a case where the temperature in the booth is as low as 15° C. for instance, since an optimum paint adhesion NV can be obtained by raising the temperature of the shield air, an optimum coating finish can be obtained by adjusting the temperature of the shield air, without raising the temperature in the booth.

1. A spray coating apparatus which possesses a casing and a cylindrical injection nozzle provided in a tip side of the casing and which forms a coating pattern by injecting paint and shaping air from the injection nozzle to thereby form a coating film on a coating object, wherein;
a first adapter which is provided on an substantially concentric circle of the injection nozzle and which blows off the air in an injection direction of the injection nozzle, and
the first adapter, by blowing off the introduced air while giving it a blowoff angle slanting toward a circumferential direction, covers an outer periphery of the coating pattern near the injection nozzle with that air.

2. A spray coating apparatus of claim 1, wherein the first adapter having an air induction part formed by a double cylinder, an air inlet and an air blowoff port which are formed in both ends of the air induction part, and plural helical grooves formed in an inner periphery face of the air induction part from the air inlet to the air blowoff port.

3. A spray coating apparatus of claim 2, wherein the first adapter is divided in a direction from the air inlet to the air blowoff port into plural pieces, and each of the pieces is made rotatable in the circumferential direction.

4. A spray coating apparatus of claim 1, wherein the first adapter is a hollow cylindrical body and possesses plural air induction holes formed in the cylindrical body while being slanted at a predetermined angle from the air inlet to the air blowoff port.

5. A spray coating apparatus of claim 1, wherein the first adapter possesses an air induction part formed by a double cylinder, an air inlet and an air blowoff port which are formed in both ends of the air induction part, and a movable guide vane which extends from the air inlet side to the air blowoff port side and which partitions an internal space of the first adapter.

6. A spray coating apparatus of claim 1, wherein the first adapter is detachable in order to be exchanged with a form corresponds to a shape of the coated object.

7. A spray coating apparatus having a casing and a cylindrical injection nozzle provided in a tip side of the casing which forms a coating pattern by injecting paint and shaping air from the injection nozzle to thereby forming a coating film on a coated object, wherein;
a second adapter which is disposed on an substantially concentric circle of the injection nozzle from the injection nozzle side toward an outside and which has plural blowoff layers respectively blowing off the air in an injection direction of the injection nozzle, and
an innermost side among the blowoff layers covers an outer periphery of the coating pattern near the coated object by the blown-off. air and an outermost side among the blowoff layers prevents by the blown-off air a diffusion of the air blown off from an inner side among the blowoff layers.

8. A spray coating apparatus having a casing and a cylindrical injection nozzle provided in a tip side of the casing and which forms a coating pattern by injecting paint and shaping air from the injection nozzle to thereby form a coating film on a coated object, wherein;
a first adapter which is provided adjacently to the injection nozzle and on an substantially concentric circle of the injection nozzle and which blows off the air in an injection direction of the injection nozzle, and a second adapter which is disposed outwardly than the first adapter and on the substantially concentric circle of the injection nozzle from the injection nozzle side toward an outside and which has plural blowoff layers respectively blowing off the air in the injection direction of the injection nozzle,
the first adapter covers, by blowing off the introduced air while giving it a blowoff angle slanting toward a circumferential direction, an outer periphery of the coating pattern near the injection nozzle with that air, and
in the second adapter, an inner side among the blowoff layers covers the outer periphery of the coating pattern near the coated object by the blown-off air and an outermost side among the blowoff layers prevents by the blown-off air a diffuision of the air blown off from an inner side among the blowoff layers.

9. A spray coating apparatus of claim 1, wherein an air generator connected to one or two or more of the injection nozzle, the first adapter or the second adapter adjusts at least one of a temperature, a humidity and an air volume.

10. A spray coating apparatus of claim 1, wherein a control unit computes a temperature, a humidity, a gas quantity and an angle of the air blown off from the adapter in compliance with a kind of the paint and a shape of the coated object, and controls the air generator and the coating machine based on the results of this computation.

11. A spray coating method which forms a coating pattern by injecting paint and shaping air from an injection nozzle of a spray coating apparatus to thereby form a coating film on a coated object,
wherein using the coating apparatus having a first adapter provided on an substantially concentric circle of the injection nozzle blows off the air in an injection direction of the injection nozzle, and
the coating is performed such that, within a range where no turbulence occurs in the coating pattern, the air blown off from an air blowoff port while being given a slanting blowoff angle covers an outer periphery of the coating pattern near the injection nozzle.

12. A spray coating method which forms a coating pattern by injecting paint and shaping air from an injection nozzle of a spray coating apparatus to thereby form a coating film on a coated object,
wherein a use of the coating apparatus having a second adapter which is disposed on an substantially concentric circle of the injection nozzle from the injection nozzle side toward an outside which has plural blowoff layers respectively blowing off the air in an injection direction of the injection nozzle, and
the coating is performed such that, within a range where no turbulence occurs in the coating pattern, an innermost side of the blowoff layers covers an outer periphery of the coating pattern near the coated object by the blown-off air and an outermost side among the blowoff layers prevents by the blown-off air a diffusion of the air blown off from an inner side among the blowoff layers.

13. A spray coating method which forms a coating pattern by injecting paint and shaping air from an injection nozzle of a spray coating apparatus to thereby form a coating film on a coated object,
wherein a use of the coating apparatus having a first adapter which is provided adjacently to the injection nozzle and on an substantially concentric circle of the injection nozzle and which blows off the air in an injection direction of the injection nozzle while giving it a slanting blowoff angle, and a second adapter which is disposed further outwardly than the first adapter and on an substantially concentric circle of the injection nozzle from the injection nozzle side toward an outside and which has plural blowoff layers respectively blowing off the air in the injection direction of the injection nozzle, and
the air blown off from the first adapter covers an outer periphery of the coating pattern near the injection nozzle and, as to the air blown off from the second adapter, an innermost side among the blowoff layers covers an outer periphery of the coating pattern near the coated object by the blown-off air and an outermost side among the blowoff layers prevents by the blown-off air a diffusion of the air blown off from an inner side among the blowoff layers, and
the coating is performed such that, within a range where no turbulence occurs in the coating pattern, the airs blown off from the first adapter and the second adapter cover a whole outer periphery of the coating pattern in cooperation with each other.

14. A spray coating method of claim 11, wherein the coating is performed by adjusting a temperature and a solvent quantity, which form the coating pattern, in compliance with a kind of the paint and a shape of the coated object by using an air generator which adjusts at least one of a temperature, a humidity and a gas quantity.

15. A spray coating method of claim 14, characterized in that air generated from the air-generator is one used also as the shaping air.

16. A spray coating method of claim 11, wherein controlling an air blowoff quantity from the first adapter and/or the second adapter to thereby cause it to substantially coincide with an induction flow rate generated due to the shaping air, a gas quantity and a wind speed of the air when the air arrives at the coated object are made unchangeable from when the air blowoff is null, while maintaining a temperature/humidity adjusting function by the air blown off from each of the adapters.
